(19) United States
(12) Patent Application Publication
(10) Pub. No.: US 2006/0274417 A1
(43) Pub. Date: Dec. 7, 2006

(54) Optical integrated unit and optical pickup

(75) Inventors: Yasunori Kanazawa, Sakurai-shi (JP); Makoto Horiyama, Nara-shi (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/412,305

(22) Filed: Apr. 26, 2006

(30) Foreign Application Priority Data
Apr. 27, 2005 (JP) 2005-130561

(51) Int. Cl. G02B 5/18

(52) U.S. Cl. 359/566

(57) ABSTRACT

In order to realize a more stable recording/reproducing performance by minimizing decrease of light utilization efficiency, an optical integrated unit 1 of the present invention includes: (i) a semiconductor laser 11 for emitting a light beam 20 to an optical disk 4; (ii) a light receiving element 12 for receiving returning light, which is the light beam 20 reflected by the optical disk 4; (iii) a transparent element 15 for diffracting P polarization component light of the light beam 20 in a direction toward the optical disk 4, and for diffracting S polarization component light of the returning light in a direction toward the light receiving element; and (iv) a ¼ wavelength plate 16 that is provided on a portion, through which the returning light enters the transparent element 15, of the transparent element 15, and that converts the returning light into the S polarization component light.

This Nonprovisional application claims priority under 35 U.S.C. § 119(a) on Patent Application No. 2005/130561 filed in Japan on Apr. 27, 2005, the entire contents of which are hereby incorporated by reference.

### FIELD OF THE INVENTION

The present invention relates to an optical integrated unit and an optical pickup. More specifically, the present invention relates to (i) an optical integrated unit allowing realization of downsizing of an optical pickup for use in recording information onto or reproducing information from and optical information recording medium such as an optical disk, and (ii) an optical pickup including the optical integrated unit.

### BACKGROUND OF THE INVENTION

Strongly demanded in recent years are (i) higher density and larger information recording capacity in an optical information recording medium such as an optical disk for the sake of storing a large amount of information, and (ii) downsizing and weight saving of an optical pickup for the sake of a mobile use thereof.

Proposed in response to such a demand of the downsizing and the weight saving are integrated pickups of various types. Most of such integrated pickups use semiconductor lasers as light sources, respectively. However, such semiconductor laser light sources, each provided in an optical pickup, generally emit laser light whose intensity distribution is the gauss type distribution. Therefore, the light flux of the laser light emitted from each of the semiconductor laser sources has such a light intensity that decreases as further from the central portion of the light flux toward an outer side with respect to the central portion thereof.

This makes it impossible to form a fine spot of the laser beam on the optical disk. This is one of reasons for deteriorations in (i) resolution limit for a reproduction signal and (ii) an S/N ratio thereof. In order to solve such a problem, for example, Patent document 1 (Japanese Unexamined Patent Publication Tokukai 2001-134972 (published on May 18, 2001) proposes (i) a semiconductor laser module using a linear diffraction grating or hologram diffraction grating, and (ii) an optical information reproducing apparatus using the semiconductor laser module. With reference to FIG. 15 and FIG. 16, the following explains respective principles of the semiconductor laser module and the optical information reproducing apparatus using the semiconductor laser module.

FIG. 15 is a diagram schematically illustrating the optical pickup. As shown in FIG. 15, a semiconductor laser light source 101 is provided in an optical integrated unit 106, and emits outgoing light 110 to a three-beam generating diffraction grating 114. When the outgoing light 110 enters the three-beam generating diffraction grating 114, the outgoing light 110 is divided into a main beam (0-order diffraction light beam) and sub beams (±1st order diffraction light beams), with the result that three outgoing light beams 111 are obtained. For simplicity, the sub beams (±1st order diffraction light beams) are not shown in FIG. 15.

The three outgoing light beams 111 thus obtained pass through a transparent element 103, and then enter a linear diffraction grating or hologram diffraction grating 104 made up of land portions and groove portions. The three outgoing light beams 111 are further divided into nine light beams made up of 0-order light beams and ±1st order light beams. Before entering the linear diffraction grating or hologram diffraction grating 104, each of the three outgoing light beams 111 has such a light flux that the light intensity in the outer peripheral portion of the beam is weaker than that in the central portion thereof. The linear diffraction grating or hologram diffraction grating 104 is set such that each of the 0-order light beams will have a weak light intensity in its central portion and will have a strong light intensity in its outer peripheral portion. Therefore, when the three outgoing light beams 111 passes through such a linear diffraction grating or hologram diffraction grating 104, each of the 0-order light beams has a light intensity distribution closer to a flat light intensity distribution. In other words, the linear diffraction grating or hologram diffraction grating 104 has the portions whose diffraction efficiencies are different from each other, so that the light intensity distribution of the 0-order diffraction light beam is closer to such a flat light intensity distribution.

In this way, each of the three 0-order diffraction light beams 111a of the nine light beams divided from the three outgoing light beams 111 is caused to have such a flat light intensity distribution. Then, the 0-order diffraction light beams are caused to be parallel light beams by a collimator lens 104. Then, the parallel light beams are collected on an optical disk 109 by an objective lens 108. The light beams thus collected are so reflected by the optical disk 109 as to be returning light beams 112. The returning light beams 112 pass through the objective lens 108, the collimator lens 107, and the linear diffraction grating or hologram diffraction grating 104. Upon the passing, the linear diffraction grating or hologram diffraction grating 104 divides the returning light beams 112 into divided returning light beams 113, and the divided returning light beams 113 are led to multiple division light detector 105. By calculating an output of the multiple division light detector 105, a predetermined information signal is obtained. Note that: for simplicity, FIG. 15 only illustrates a light beam of the returning light beams 112, which light beam has a center coinciding with the optical axis of the returning light beams 12.

Each of FIG. 16 is an explanatory diagram illustrating one example of a detailed structure of the linear diffraction grating or hologram diffraction grating 104. See FIG. 16. The linear diffraction grating or hologram diffraction grating 104 has grating grooves 115 each of whose grating groove width, each of whose grating pitch, and each of whose grating groove depth are set such that: the light intensity of the 0-order diffraction light beam is weak in the central portion of the linear diffraction grating or hologram diffraction grating 104, and the light intensity thereof is strong in the outer peripheral portion of the linear diffraction grating or hologram diffraction grating 104. In other words, the grating groove widths of the grating grooves 115 becomes smaller than the half of the length of the grating pitch, as further from the central portion in the direction perpendicular to the direction in which the grating is provided.

As such, the outgoing light needs to pass through the central portion of the linear diffraction grating or hologram diffraction grating 104 so as to have the flat light intensity distribution. Further, the position of the transparent member 103 needs to be adjusted such that the outgoing light passes through the central portion of the linear diffraction grating or hologram diffraction grating 104. Further, the transparent member 103 also needs to be adjusted such that: each of the returning light beams 112 from the optical disk 109 passes through the predetermined portion of the linear diffraction grating or hologram diffraction grating 104, and is led to the multiple division light detector 105.

However, such a conventional optical integrated unit suffers from the following problems. That is, the outgoing light emitted from the light source enters the three-beam generating diffraction grating 114, with the result that the outgoing light is divided into the three light beams, i.e., the 0-order light beam and the ±1st order light beams. Upon the dividing, the light diffraction phenomenon causes decrease of the light intensity of each of the three light beams, with the result that light amount loss occurs. Moreover, the entering of the three outgoing light beams into the linear diffraction grating or hologram diffraction grating 104 causes generation of the nine light beams made up of (i) the 0-order light beams each of whose intensity distribution is corrected and (ii) the ±1st order light beams; however, only the three 0-order light beams of the nine light beams are used for the recording and/or the reproduction, and the rest of the light beams are not used therefor. Thus, light amount loss also occurs in this case. This is one reason for the decrease of the light utilization efficiency.

Further, such light amount loss also occurs when each of the returning light beams 112 passes through the linear diffraction grating or hologram diffraction grating 104. This causes further decrease of the light utilization efficiency.

In cases where the optical pickup is designed in consideration of the decrease of the light utilization efficiency, the power of the semiconductor laser needs to be stronger for the sake of realizing stable recording/reproduction performance. However, the strengthening of the power of the semiconductor laser causes short durability of the semiconductor laser.

The decrease of the light utilization efficiency occurs not only in (i) the optical information reproducing apparatus described in Patent document 1 and including the linear diffraction grating or hologram diffraction grating having the aforementioned optical intensity distribution correction function, but also in (ii) an optical information reproducing apparatus including a three-beam generating diffraction grating having no light intensity distribution correction function.

### SUMMARY OF THE INVENTION

The present invention is made in light of the problems, and its object is to provide an optical integrated unit and an optical pickup, each of which allows more stable recording/reproducing performance by correcting the intensity of light, emitted from a light source, so as to minimize decrease of light utilization efficiency.

To achieve the object, an optical integrated unit of the present invention includes: a light source for emitting a light beam including first polarization component light, to an optical information recording medium; a light receiving element for receiving returning light, which is the light beam reflected by the optical information recording medium; diffracting means for diffracting the first polarization component light in a direction toward the optical information recording medium such that decrease of light intensity of the light beam is smaller as further from a vicinity of an optical axis of the light beam toward a peripheral portion of the light beam; and polarization component converting means, which is provided in a light path between the light source and the diffracting means, and which converts the returning light into second polarization component light different from the first polarization component light, the diffracting means diffracting the second polarization component light in a direction toward the light receiving element.

According to the above structure, the light beam emitted from the light source includes the first polarization component light, and the first polarization component light is diffracted in the direction toward the optical information recording medium. Therefore, the light beam going out from the diffracting means toward the optical information recording medium has the first polarization component.

Moreover, according to the above structure, the polarization component converting means is provided in the light path of the returning light between the optical information recording medium and the diffracting means, and the polarization component converting means converts the returning light into the second polarization component light different from the first polarization component light. Therefore, the light beam going out of the diffracting means is so reflected by the optical information recording medium as to be the returning light, and then the returning light passes through the polarization component converting means, with the result that the returning light becomes the second polarization component light. Then, the second polarization component light enters the diffracting means. According to the above structure, the diffracting means diffracts the second polarization component light in the direction toward the light receiving element, with the result that the second polarization component returning light is wholly diffracted in the direction toward the light receiving element, and the light receiving element receives such returning light.

In other words, the above structure is a structure, which uses the polarization light and which includes (i) the diffracting means for diffracting the first polarization component light in the direction toward the optical information recording medium, and for diffracting the second polarization component light in the direction toward the light receiving element; and (ii) polarization component converting means for converting the returning light into the second polarization component light. This allows the light receiving element to efficiently receive the returning light coming from the optical information recording medium. Therefore, according to the above structure, the light beam diffracted by the diffracting means in the direction toward the optical information recording medium can be wholly used for detection of a signal, with the result that the light utilization efficiency becomes very high.

Therefore, the above structure makes it possible to provide an optical pickup, which does not need to use, e.g., a semiconductor laser having a strong power in cases where the light source is a semiconductor laser, and which costs low, and which has a stable recording/reproducing performance.

Further, the diffracting means diffracts the first polarization component light in the direction toward the optical information recording medium such that the decrease of the light intensity of the light beam is smaller as further from the vicinity of the optical axis of the light beam to the peripheral portion thereof. On this account, the light intensity distribution of the first polarization component light thus diffracted by the diffracting element in the direction toward the optical information recording medium is so corrected as to be closer to a flat light intensity distribution, and then the first polarization component light is collected on the optical information recording medium. This makes it possible to form a finer spot of the light beam on the optical information recording medium, with the result that the temporal resolution with respect to a reproduction signal is improved and the S/N ratio of the reproduction signal is improved.

As described above, the above structure makes it possible to provide an optical pickup which minimizes decrease of the light utilization efficiency by correcting the intensity of the light beam emitted from the light source.

To achieve the object, an optical pickup of the present invention includes the above optical integrated unit.

This allows minimization of decrease of the light utilization efficiency, with the result that the optical pickup of the present invention is allowed to have more stable recording/reproducing performance.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1(a) is a side view schematically illustrating an optical integrated unit of Embodiment 1 of the present invention.

FIG. 1(b) is an overview illustrating the optical integrated unit shown in FIG. 1(a), when viewed from the side of a window portion 17d.

FIG. 2 is a diagram schematically illustrating a structure of an optical pickup using the optical integrated unit shown in FIG. 1.

FIG. 3(a) is an overview illustrating the structure of the hologram pattern of a first polarization light diffracting element used in the optical integrated unit shown in FIG. 1, when the hologram pattern is viewed in the optical axis direction.

FIG. 3(b) is a cross sectional view which illustrates the structure of the hologram pattern of the first polarization light diffracting element used in the optical integrated unit shown in FIG. 1, and which is taken along line A-A′.

FIG. 4 is a diagram schematically illustrating the hologram pattern of a second polarization light diffracting element used in the optical integrated unit shown in FIG. 1.

FIG. 5(a) is an explanatory diagram illustrating how light beams incident on the pattern of light receiving sections of a light receiving element used in the unit of the present invention, in cases where no spherical aberration occurs.

FIG. 5(b) is a diagram illustrating how the light beams incident thereon in cases where the objective lens moves closer to the optical disk from the state shown in FIG. 5(a).

FIG. 6(a) is a diagram schematically illustrating a state of a second polarization light diffracting element when returning light beams, i.e., beams reflected by the optical disk 4 are displaced from the central portion of the second polarization light diffracting element in the +X direction of the X direction under conditions that the optical axis direction is considered as the Z direction.

FIG. 6(b) is a diagram schematically illustrating a state of the second polarization light diffracting element when the returning light beams, i.e., the beams reflected by the optical disk 4 are displaced from the central portion of the second polarization light diffracting element in the −X direction of the X direction under conditions that the optical axis direction is considered as the Z direction.

FIG. 7(a) is a diagram schematically illustrating a state of the second polarization light diffracting element when the returning light beams, i.e., the beams reflected by the optical disk 4 are displaced from the central portion of the second polarization light diffracting element in the +Y direction of the Y direction under conditions that the optical axis direction is considered as the Z direction.

FIG. 7(b) is a diagram schematically illustrating a state of the second polarization light diffracting element when the returning light beams, i.e., the beams reflected by the optical disk 4 are displaced from the central portion of the second polarization light diffracting element in the −Y direction of the Y direction under conditions that the optical axis direction is considered as the Z direction.

FIG. 8(a) is a side view schematically illustrating an optical integrated unit of Embodiment 2 of the present invention.

FIG. 8(b) is an overview illustrating the optical integrated unit shown in FIG. 1(a), when viewed from the side of a window portion 17d.

FIG. 9(a) is an overview illustrating the structure of the hologram pattern of a first polarization light diffracting element used in the optical integrated unit shown in FIG. 8, when the hologram pattern is viewed in the optical axis direction.

FIG. 9(b) is a cross sectional view which illustrates the structure of the hologram pattern of the first polarization light diffracting element used in the optical integrated unit shown in FIG. 8, and which is taken along line B-B′.

FIG. 10 is a side view schematically illustrating an optical integrated unit of Embodiment 3 of the present invention.

FIG. 11 is a side view schematically illustrating an optical integrated unit of Embodiment 4 of the present invention.

FIG. 12 is a diagram for explaining a hologram region of a first polarization light diffracting element of an optical integrated unit of Embodiment 5 of the present invention, and illustrates a relation among (i) a light beam to be diffracted by the hologram region, (ii) the size of the light flux of the light beam emitted from a semiconductor laser, and (iii) the size of the light flux of light beams to be collected on an optical disk.

FIG. 13 is a diagram schematically illustrating another structure of the optical pickup of the present invention.

FIG. 14 is a diagram schematically illustrating still another structure of the optical pickup of the present invention.

FIG. 15 is a diagram schematically illustrating a structure of a conventional optical pickup.

FIG. 16(a) is an overview illustrating one example of a detailed structure of a linear diffraction grating or hologram diffraction grating of the optical pickup shown in FIG. 15, when the structure is viewed in the optical axis direction.

FIG. 16(b) is a cross sectional diagram, which illustrates the diffraction grating shown in FIG. 16(a) and which is taken along line A-A′.

### DESCRIPTION OF THE EMBODIMENTS

### Embodiment 1

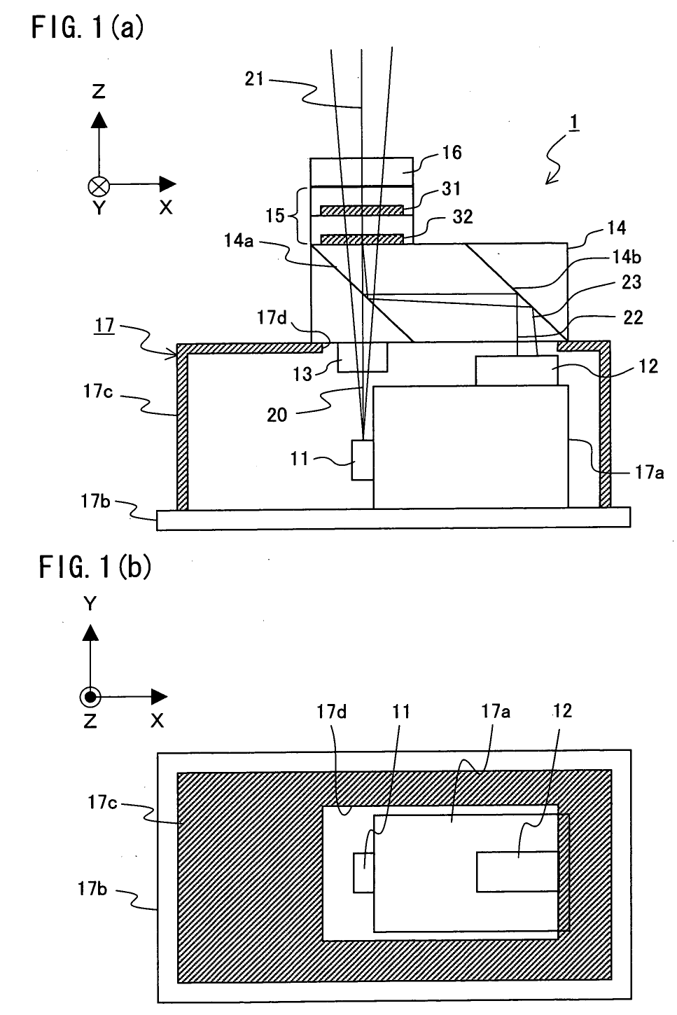

One embodiment of the present invention will be described below with reference to FIGS. 1(a) and 1(b) through FIGS. 7(a) and 7(b).

The present embodiment assumes a case where an optical integrated unit of the present invention is used in an optical pickup provided in an optical information recording/reproducing apparatus for optically recording and reproducing information onto and from an optical disk (optical information recording medium).

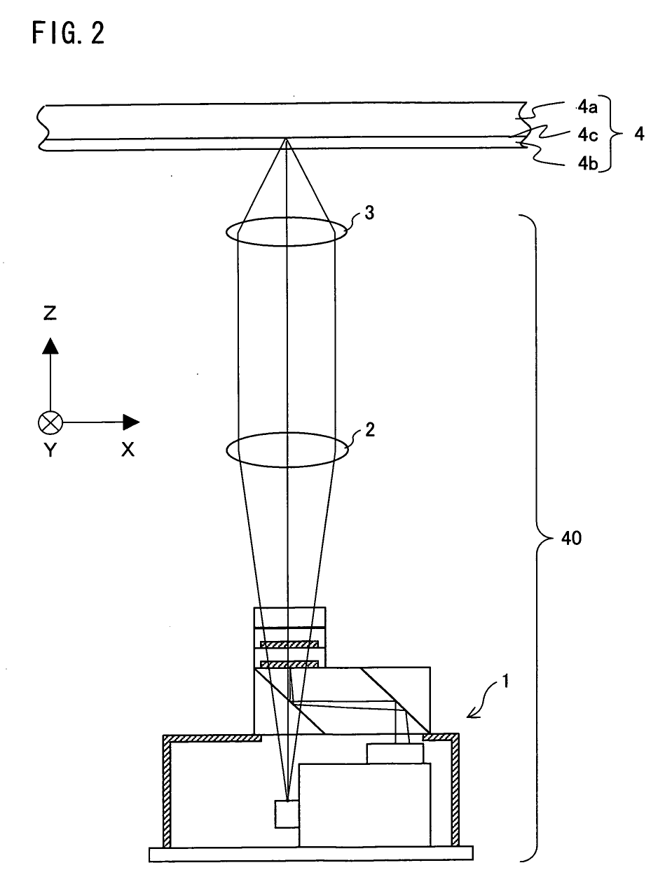

FIG. 2 is a diagram schematically illustrating a structure of an optical pickup 40 using an optical integrated unit of the present embodiment.

As shown in FIG. 2, the optical pickup 40 includes the optical integrated unit 1, a collimator lens 2, and an objective lens 3.

In FIG. 2, a light beam emitted from a light source provided in the optical integrated unit 1 is caused to be parallel light beams by the collimator lens 2, and then the parallel light beams are collected on an optical disk 4 by the objective lens 3. Then, the light beams (hereinafter, referred to as “returning light beams (returning light)”) reflected by the optical disk 4 pass through the objective lens 3 and the collimator lens 2, and are collected on a light receiving element provided in the optical integrated unit 1.

The optical disk 4 is made up of (i) a substrate 4a, (ii) a cover layer 4b through which the light beam pass, and (iii) a recording layer 4c. The recording layer 4c is provided in a boundary between the substrate 4a and the cover layer 4b. Further, the objective lens 3 is driven in the focusing direction (Z direction) and the tracking direction (X direction) by an objective lens driving mechanism (not shown) such that a spot of the collected light beams follows a predetermined position of the recording layer 4c even when the optical disk 4 is vibrated or is displaced from the rotation axis.

Explained in the present embodiment is a case where the optical integrated unit 1 includes a short wavelength light source for emitting light having a wavelength of approximately 405 nm, and where a high NA objective lens having an NA of approximately 0.85 is provided as the objective lens 3. However, the present invention is not limited to this. However, the optical integrated unit 1 thus including such a short wavelength light source and the high NA objective lens allows high density recording/reproduction.

In cases where the short wavelength light source is adopted as the light source and the high NA objective lens is adopted as the objective lens 3 as such, a large spherical aberration occurs due to a thickness error in the cover layer 4b of the optical disk 4. In order to correct the spherical aberration occurring due to the thickness error, the optical pickup 40 is arranged such that: (i) the position of the collimator lens 2 is adjusted by a collimator lens driving mechanism (not shown) in the optical axis direction, or (ii) the space is adjusted by a beam expander driving mechanism (not shown) between two lenses making up a lens group constituting a beam expander (not shown) provided between the collimator lens 2 and the objective lens 3.

Explained next is a structure of the optical integrated unit 1 shown in FIG. 2, with reference to FIG. 1(a) and FIG. 1(b) each illustrating a schematic structure of the optical integrated unit 1. FIG. 1(a) is a side view illustrating the structure of the optical integrated unit 1 when viewed in the optical axis direction (Y direction shown in FIG. 1(a)).

As shown in FIG. 1(a), the optical integrated unit 1 includes: a semiconductor laser (light source) 11, a light receiving element 12, a ½ wavelength plate 13, a polarization beam splitter (light guiding means) 14, a transparent element (diffracting means) 15, a ¼ wavelength plate (polarization light component converting means) 16, and a package 17.

The package 17 is made up of a stem 17a, a base 17b, and a cap 17c. Formed in the cap 17c is a window portion 17d through which light passes. Provided in the package 17 are the semiconductor laser 11 and the light receiving element 12. Specifically, the semiconductor laser 11 and the light receiving element 12 are provided on the stem 17a of the package 17. The polarization beam splitter 14 is so manufactured as to have a size sufficiently larger than the area of the window portion 17d. Such a polarization beam splitter 14 is adhered and fixed on the cap 17c, with the result that the package 17 is sealed by the polarization beam splitter 14. With this, the semiconductor laser 11 and the light receiving element 12 are not exposed to outside air, so that respective properties of the semiconductor laser 11 and the light receiving element 12 are less likely to be deteriorated.

FIG. 1(b) is an overhead view illustrating the package 17 when viewed in the optical axis direction (Z direction) shown in FIG. 1(a), i.e., when viewed from the side of the window portion 17d of the cap 17c. Explained with reference to FIG. 1(b) is how the semiconductor laser 11 and the light receiving element 12 are disposed in the package 17. For simplicity, FIG. 1(b) does not illustrate the ½ wavelength plate 13, the polarization beam splitter 14, the transparent element 15, and the ¼ wavelength plate 16.

As shown in FIG. 1(b), the light receiving element 12 is provided on the stem 17a, and the semiconductor laser 11 is provided on a side portion of the stem 17a. In the optical integrated unit 1, the light receiving element 12 and the semiconductor laser 11 are provided such that a light beam emitting portion of the semiconductor laser 11 and a light receiving portion of the light receiving element 12 are positioned within a region defined by the window portion 17d of the cap 17c.

Explained next is how the members of the optical integrated unit 1 are disposed, with reference to FIG. 1(a). For ease of explanation, it is assumed in the following explanation that: (i) a surface, via which a light beam 20 emitted from the semiconductor laser 11 enters the polarization beam splitter 14, of the polarization beam splitter 14 is referred to as “light beam entrance surface” of the polarization beam splitter 14; (ii) a surface, via which the returning light beams enter the polarization beam splitter 14, of the polarization beam splitter 14 is referred to as “returning light entrance surface” of the polarization beam splitter 14; (iii) a surface, via which a light beam 20 emitted from the semiconductor laser 11 enters the transparent element 15, of the transparent element 15 is referred to as “light beam entrance surface” of the transparent element 15; and (iv) a surface, via which the returning light beams enter the transparent element 15, of the transparent element 15 is referred to as “returning light entrance surface” of the transparent element 15.

As shown in FIG. 1(a), the polarization light beam splitter 14 is provided on the package 17 such that the window portion 17d is covered by the light beam entrance surface of the polarization beam splitter 14.

Further, the light beam entrance surface of the transparent element 15 is so positioned as to be face to face with the returning light entrance surface of the polarization beam splitter 14, and as to cross with the optical axis of the light beam 20 to be emitted from the semiconductor laser 11.

Provided between the semiconductor laser 11 and the polarization light beam splitter 14 in the optical integrated unit 1 is the ½ wavelength plate 13. That is, the ½ wavelength plate 13 is so provided on the light beam entrance surface of the polarization light beam splitter 14 as to cross with the optical axis of the light beam 20 to be emitted from the semiconductor laser 11.

Further, the ¼ wavelength plate 16 is so provided on the returning light entrance surface of the transparent element 15 as to cross with the optical axis of the light beam 20 to be emitted from the semiconductor laser 11.

Explained next is a passage route of the light beam inside the optical integrated unit 1.

As described above, the semiconductor laser 11 is a semiconductor laser emitting the light beam 20 having a wavelength λ of 405 nm. Moreover, the light beam 20 emitted from the semiconductor laser 11 is linear polarization light (S polarization light) polarized in the Y direction. That is, the light beam 20 emitted from the semiconductor laser 11 is light including a component of a linear polarization light beam (S polarization light beam) polarized in the Y direction when the optical axis direction (see FIG. 1(a)) is considered as the Z direction.

The light beam 20 emitted from the semiconductor laser 11 enters the ½ wavelength plate 13. The ½ wavelength plate 13 has a property of converting (i) the light beam 20 including the S polarization light beam component and emitted from the semiconductor laser 11, into (ii) a linear polarization light beam (P polarization light beam) polarized in the X direction when the optical axis direction (see FIG. 1(a)) is considered as the Z direction.

The light beam (first polarization component light) 20 thus converted into the P polarization light beam by the ½ wavelength plate 13 enters the polarization beam splitter 14. The polarization beam splitter 14 has a polarization light beam splitter (PBS) surface 14a, and a reflective mirror surface 14b.

The PBS surface 14a of the polarization beam splitter 14 has the following property: the PBS surface 14a allows passing of a linear polarization light beam (P polarization light) polarized in the X direction when the optical axis direction is considered as the Z direction, but reflects a linear polarization light beam (second polarization component light; S polarization light) polarized in the direction perpendicular to the X direction, i.e., reflects the linear polarization light beam polarized in the Y direction when the optical axis direction shown in FIG. 1(a) is considered as the Z direction. In other words, depending on the direction (polarization direction) in which an incoming light beam is polarized, i.e., depending on whether the light beam is the S polarization light or the P polarization light, the PBS surface 14a allows the light beam to pass therethrough or reflects the light beam. The following explains how the PBS surface 14a of the polarization light beam splitter 14 is given such selectivity that the polarization direction of the light beam determines whether or not the light beam 20 passes therethrough.

Generally speaking, a P polarization light beam and an S polarization light beam are different from each other in terms of their reflection properties. The S polarization light beam has such a reflection property that: the S polarization light beam is more likely to be reflected, as an incident angle with respect to the entrance surface (incident surface; the PBS surface 14a) is larger. On the other hand, the P polarization light beam has such a reflection property that: the P polarization light beam is never reflected when an incident angle thereof is the Brewster angle, and passes through the entrance surface (incident surface; the PBS surface 14a). This indicates that there is an incident angle at which the S polarization light beam is reflected but the P polarization light beam passes through the entrance surface. A thin film utilizing such a difference between the reflection properties of the P polarization light beam and the S polarization light beam is used in the polarization light beam splitter 14. Specifically, the PBS surface 14a is formed so that the incident angle at which the light beam 20 emitted from the semiconductor laser 11 incidents on the PBS surface 14a is the Brewster angle.

Further, the PBS surface 14a is so positioned as to cross with the optical axis of the light beam 20 having been converted into the P polarization light beam by the ½ wavelength plate 13. Further, the reflective mirror surface 14b is positioned in parallel with the PBS surface 14a.

The size of the polarization light beam splitter 14 is not particularly limited as long as (i) the light beam 20 emitted from the semiconductor laser 11 passes therethrough and (ii) the returning light beams, i.e., the light beams having been reflected by the optical information recording medium are so reflected by the reflective mirror 14b as to be received by the light receiving element 12. However, it is preferable that the size of the light beam splitter 14 be sufficiently larger than the area of the window portion 17d formed in the cap 17c of the package 17. In cases where the polarization light beam splitter 14 is sufficiently larger than the area of the window portion 17d of the cap 17c, the polarization light beam splitter 14 can be adhered and fixed on the cap 17c. With this, the package 17 is sealed, so that the semiconductor laser 11 and the light receiving element 12 are not exposed to the outside air. On this account, respective properties of the semiconductor laser 11 and the light receiving element 12 are less likely to be deteriorated.

The light beam 20 (P polarization light beam) enters and passes through the PBS surface 14a, with the result that the light beam 20 becomes a P polarization light beam 21. The P polarization light beam 21 having passed through the PBS surface 14a enters the transparent element 15.

As described above, in the optical integrated unit 1, the ½ wavelength plate 13 is provided in the light path between the semiconductor laser 11 and the polarization light beam splitter 14. In cases where the ½ wavelength plate 13 is not provided therein, the light beam 20 emitted from the semiconductor laser 11 is kept to be the linear polarization light beam (S polarization light beam) polarized in the Y direction and incidents on the polarization light beam splitter 14. Accordingly, the light beam 20 is almost entirely reflected by the PBS surface 14a of the polarization light beam splitter 14, with the result that light amount loss occurs. For this reason, in the present embodiment, the ½ wavelength plate 13 is provided in the light path between the semiconductor laser 11 and the polarization light beam splitter 14 such that the light beam 20 is converted into the linear polarization light beam (P polarization light beam) polarized in the X direction. This allows the P polarization light beam to wholly pass through the PBS surface 14a of the polarization light beam splitter 14.

The following fully explains the transparent element 15. The transparent element 15 has surfaces which are opposite to each other, and on which a first polarization light diffracting element 31 having a first hologram region and a second light diffracting element 32 having a second hologram region are respectively provided.

The first polarization diffracting element 31 and the second polarization diffracting element 32 are so provided as to cross with the optical axis of the light beam 20. Further, the second polarization light diffracting element 32 is provided between the first polarization diffracting element 31 and the semiconductor laser 11.

The first hologram region of the first polarization light diffracting element 31 diffracts the P polarization light beam, and allows the S polarization light beam to pass therethrough. The second hologram region of the second polarization light diffracting element 32 diffracts the S polarization light beam, and allows the P polarization light beam to pass therethrough. Specifically, the light beam is diffracted by each of groove structures (gratings) formed in the respective hologram regions of the polarization diffracting elements. A diffraction angle is determined by a pitch (hereinafter, referred to as “grating pitch”) of each of the groove structures (gratings). Note that a hologram pattern in each of the respective hologram regions of the first polarization light diffracting element 31 and the second polarization light diffracting element 32 will be fully explained later.

The P polarization light beam 21 having passed through the PBS surface 14a passes through the second polarization light diffracting element 32 without being diffracted, and enters the first polarization light diffracting element 31. Formed in the first polarization light diffracting element 31 is a hologram pattern used for generation of three beams for use in detecting a tracking error signal (TES). Examples of a method for detecting the TES by using the three beams include: the three-beam method, and the differential push-pull (DPP) method.

The first polarization diffracting element 31 diffracts the P polarization light (component) of the light beam entered therein, and allows the S polarization light (component) thereof to pass therethrough. Specifically, the first polarization diffracting element 31 diffracts the P polarization light of the light beam entered therein, into a 0-order diffraction light beam (non-diffraction light beam) and ±1st order diffraction light beams (non-diffraction light beams).

In other words, after passing through the second polarization light diffracting element 32, the P polarization light beam 21 enters the first polarization light diffracting element 31, and is diffracted by the first polarization light diffracting element 31 into the 0-order diffraction light beam (main beam) and the ±1st order diffraction light beams (sub beams), and then these beams go out of the first polarization light diffraction element 31.

The P polarization light beams 21 thus obtained by diffracting the P polarization light beam 21 by the first polarization light diffracting element 31 enter the ¼ wavelength plate 16. The ¼ wavelength plate 16 receives a linear polarization light beam and converts the linear polarization light beam into a circular polarization light beam. Therefore, the P polarization light beams 21 (linear polarization light beams) having entered the ¼ wavelength plate 16 is converted into circular polarization light beams, and the circular polarization light beams go out of the optical integrated unit 1.

The circular polarization light beams go out of the optical integrated unit 1 as such, and then are caused to be parallel light beams by the collimator lens 2 as shown in FIG. 2. Then, the parallel light beams are collected on the optical disk 4 by the objective lens 3. The light beams reflected by the optical disk 4 (i.e., the returning light beams) pass through the objective lens 3 and the collimator lens 2, and then enter the ¼ wavelength plate 16 of the optical integrated unit 1.

Each of the returning light beams is circular polarization light before entering the ¼ wavelength plate 16 of the optical integrated unit 1. When such returning light beams enter the ¼ wavelength plate 16, the returning light beams are converted by the ¼ wavelength plate 16 into linear polarization light beams (S polarization light beams) each polarized in the Y direction. Thereafter, the S polarization returning light beams enter the first polarization light diffracting element 31.

The S polarization returning light beams thus having entered the first polarization light diffracting element 31 pass therethrough without being diffracted, and enters the second polarization diffracting element 32. When the S polarization returning light beams enter the second polarization diffracting element 32, the S polarization returning light beams are diffracted and are divided into 0-order diffraction light beams (non-diffraction light beams) 22 and ±1st order diffraction light beams (diffraction light beams) 23, and then these light beams enters the polarization beam splitter 14. The 0-order diffraction light beams 22 and the ±1st order diffraction light beams 23 (S polarization light beams) are reflected by the PBS surface 14a, and then are reflected by the reflective mirror surface 14b, and then go out of the polarization beam splitter 14. After going out of the polarization light beam splitter 14, the 0-order diffracting light beams 22 and ±1st order diffraction light beams 23 (S polarization light beams) are received by the light receiving element 12. Note that the pattern of light receiving sections of the light receiving element 12 will be described later.

As described above, the first polarization light diffracting element 31 of the transparent element 15 diffracts the P polarization light but allows the S polarization light to pass therethrough, whereas the second polarization light diffracting element 32 of the transparent element 15 diffracts the S polarization light but allows the P polarization light to pass therethrough. In other words, depending on the polarization direction of the incoming light (i.e., depending on whether the incoming light is S polarization light or P polarization light), it is determined whether the light passes through or is diffracted by each of the first polarization light diffracting element 31 and the second polarization light diffracting element 32. The following explains a principle of such selectivity that each of the first polarization light diffracting element 31 and the second polarization light diffracting element 32 allows the incoming light to pass therethrough or diffracts the incoming light, depending on the polarization direction of the incoming light. The principle of such selectivity is described in, e.g., Japanese Unexamined Patent Publication Tokukaihei 10-68820.

In the optical integrated unit of the present embodiment, a liquid crystal is provided between the first polarization light diffracting element 31 and the second polarization light diffracting element 32. Further, the first polarization light diffracting element 31 has rise portions (i.e., diffraction grating) each designed to have a refractive index coinciding with the extraordinary index (extraordinary refractive index) of the liquid crystal. On the other hand, the second polarization light diffracting element 32 has rise portions (i.e., diffraction grating) each designed to have a refractive index coinciding with the ordinary index (ordinary refractive index) of the liquid crystal. Further, liquid crystal molecules in the liquid crystal are optically anisotropic. In other words, each of the liquid crystal molecules has the ordinary index with respect to the P polarization light, but has the extraordinary index with respect to the S polarization light.

Firstly explained is the selectivity that, depending on the polarization direction of the outbound light beam (i.e., the light beam 20 emitted from the semiconductor laser 11 and including the P polarization light component), each of the first polarization diffracting element 31 and the second polarization diffracting element 32 respectively having the above structures allows the outbound light beam to pass therethrough or diffracts outbound light beam. The light beam 20 emitted from the semiconductor laser 11 enters and passes through the second polarization light diffracting element 31 without being diffracted, and then passes through the liquid crystal having the liquid crystal molecules each having the ordinary index with respect to the P polarization light component, and then enters the first polarization diffracting element 31. The refractive index of each of the rise portions (diffraction grating) of the first polarization light diffracting element 31 coincides with the extraordinary index of the liquid crystal. Meanwhile, each of the liquid crystal molecules has the ordinary index with respect to the P polarization light. Thus, the liquid crystal molecule and the first polarization diffracting element 31 have different refractive indexes with respect to the P polarization light. With this, when the light beam 20 enters the polarization light diffracting element 31, the first polarization light diffracting element 31 serves as the diffraction grating so as to diffract the light beam 20 into the 0-order diffraction light beam (non-diffraction light beam) and the ±1st order diffraction light beams (non-diffraction light beams).

Explained next is the selectivity that, depending on the polarization direction of each of the inbound light beams (i.e., the returning light beams having the S polarization light component), each of the first polarization diffracting element 31 and the second polarization diffracting element 32 respectively having the above structures allows the inbound light beams to pass therethrough or diffracts the inbound light beams. The light beams reflected by the optical disk 4, i.e., the returning light beams having the S polarization light enter and pass through the first polarization diffracting element 31 without being diffracted, and then pass through the liquid crystal having the liquid crystal molecules each having the extraordinary index with respect to the S polarization light, and then enter the second polarization light diffracting element 32. The refractive index of the rise portions (diffraction grating) of the second polarization diffracting element 32 coincides with the ordinary index of the liquid crystal; however, the liquid crystal molecule has the extraordinary index with respect to the S polarization light. Thus, the liquid crystal molecule and the second polarization diffracting element 32 have different refractive indexes with respect to the S polarization light. With this, when the returning light beams enter the second polarization light diffracting element 32, the second polarization light diffracting element 32 serves as the diffraction grating so as to diffract the returning light beams into the 0-order diffraction light beams (non-diffraction light beam) 22 and the ±1st order diffraction light beams (diffraction light beams) 23.

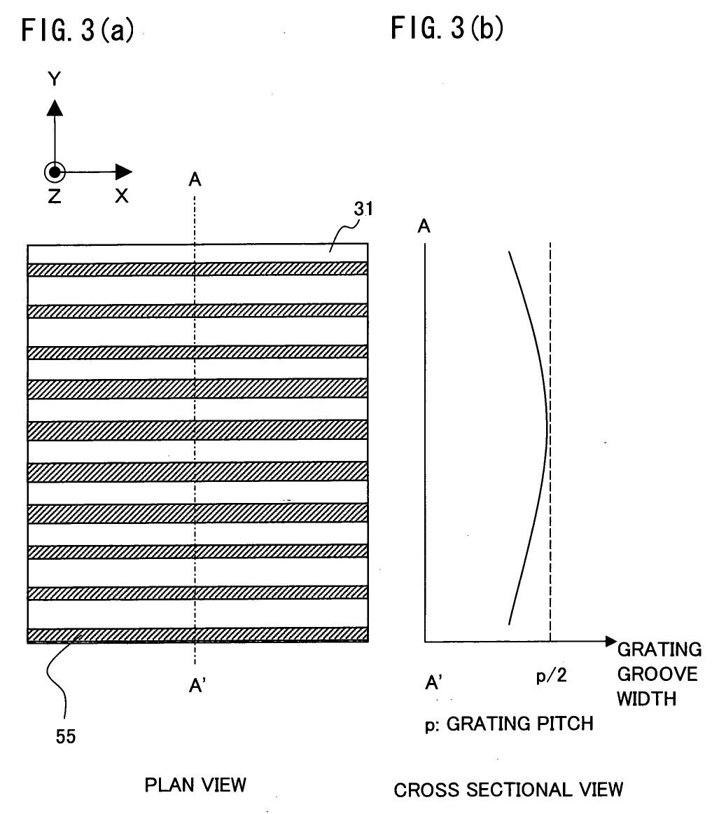

The following explains the hologram pattern formed on the first polarization diffracting element 31, with reference to FIG. 3.

Explained here is the light intensity of a light beam having entered a general linear diffraction grating. When entering the linear diffraction grating, the light beam is divided into three beams: a 0-order diffraction light beam (main beam) and ±1st order diffraction light beams (sub beams). Consider a case where the linear diffraction grating is a diffraction grating having a rectangular cross sectional surface in which grating grooves are provided. In this case, the following Formula (1) is satisfied where the grating groove width in the diffraction grating is indicated by “w”, the grating pitch therein being indicated by “p”, the grating groove depth therein being indicated by “h”, the refractive index of the transparent element 15 including the first polarization light diffracting element 31 being indicated by “n”, the wavelength of the light beam emitted from the semiconductor laser being indicated by “λ”, the light intensity of the 0-order diffraction light being indicated by “I₀”, the light intensity of each of the ±1st order diffraction light beams (hereinafter, simply referred to as “1st order diffraction light beams”) being indicated by “I₁”, the light intensity of the light beam having entered the diffraction grating being 1:

$${I}_{0} = 1 + 2 β ( β - 1 ) ( 1 - cos α ) \\ {I}_{1} = \frac{2}{{π}^{2}} {sin}^{2} ( π β ) ( 1 - cos α ) \\ α = \frac{2 π}{λ} ( n - 1 ) h \\ β = \frac{w}{p} \qquad ( 1 )$$

Formula (1) clarifies that the light intensity I₀ of the 0-order diffraction light beam and the light intensity I₁ of each of the 1st order diffraction light beams greatly depend on the grating groove width w, the grating pitch p, and the grating groove depth h. Further, the value β is larger than 0 but is smaller than 1. Therefore, as the value β is closer to 0.5, i.e., as the grating groove width w is closer to the half of the length of the grating pitch p, the light intensity of the 0-order light beam becomes weaker but the light intensity of each of the 1st order light beams becomes stronger.

Here, the direction (diffraction direction) in which each of the light beams is diffracted depends on only the grating pitch p, so that the grating groove width w and the grating groove depth h may be changed. Therefore, the grating groove width w and the grating groove depth h may be changed according to a location in the diffraction grating, with the result that the light intensity of each of the diffraction light beams can be controlled.

This is specifically explained as follows. Assume that: (i) the region, through which the light flux in the vicinity of the central portion of the optical beam 20 passes, of the first polarization diffracting element 31 shown in FIG. 1 is defined as “first region”; and (ii) the region, through which the light flux in the vicinity of the outer peripheral portion, is defined as “second region”. By changing the grating groove widths w and the grating groove depths h in the first and second regions, the light intensity of each of the diffraction light beams can be controlled. More specifically, the grating groove width in the first region of the first polarization light diffracting element 31 is caused to be closer to the half of the length of the grating pitch, whereas the grating groove width in the second region of the first polarization light diffracting element 31 is caused to be smaller than the half of the length of the grating pitch.

With this, the decrease of the light intensity of the 0-order polarization light beam (main beam) is smaller as further from (i) the portion having passed through the first region of the first polarization light diffracting element 31 (i.e., the portion in the vicinity of the central portion of the light beam 20), toward (ii) the portion having passed through the second region of the first polarization light diffracting element 31 (i.e., the portion in the vicinity of the peripheral portion of the light beam 20). That is, the decrease of the light intensity is smaller as further from the vicinity of the optical axis of the light beam 20 toward the peripheral portion of the light beam 20. Accordingly, the light intensity distribution of the 0-order diffraction light beam becomes closer to flat light intensity distribution. With this, the light beams collected by the objective lens forms a fine spot on the optical disk.

Explained here is the light beam emitted from the semiconductor laser 11. The light beam emitted from the semiconductor laser 11 expands greatly in the form of an ellipse. The light intensity distribution in the short axis direction of the light beam thus expanding in the form of the ellipse is not flat as compared with the light intensity distribution in the long axis direction thereof. Therefore, the light intensity distribution in the short axis direction needs to be so corrected as to be flat. For example, in the present embodiment, the semiconductor laser 11 emits the elliptic-like light flux whose long axis corresponds to the X direction and whose short axis corresponds to the Y direction. Therefore, the first polarization light diffracting element 31 is arranged such that the light intensity distribution thereof in the Y direction, which corresponds to the short axis direction, is corrected. More specifically, the first polarization diffracting element 31 has to be provided such that the grating groove widths w are changed in the Y direction shown in FIG. 2. With this, the light beam emitted from the semiconductor laser 11 has light intensity distribution which is flat in the Y direction that is the short axis direction of the light beam.

Each of FIG. 3(a) and FIG. 3(b) illustrates one example of the hologram pattern of the first polarization diffracting element 31 formed on the surface of the transparent element. FIG. 3(a) is a plan view and FIG. 3(b) is a cross sectional view taken along line A-A′.

As shown in FIG. 3(a), grating grooves 55 are provided in the first polarization diffracting element 31. The grating grooves 55 have grating groove widths (i) that are closer to the half of the length of the grating pitch as closer to the central portion of the first polarization diffracting element 31, and that (ii) are smaller than the half of the length of the grating pitch as further from the central portion toward the peripheral portion of the first polarization diffracting element 31. Further, the grating pitch p of the first polarization diffracting element 31 is set such that the three types of light beam (main beams and the sub beams) will be sufficiently split in the light receiving element 12.

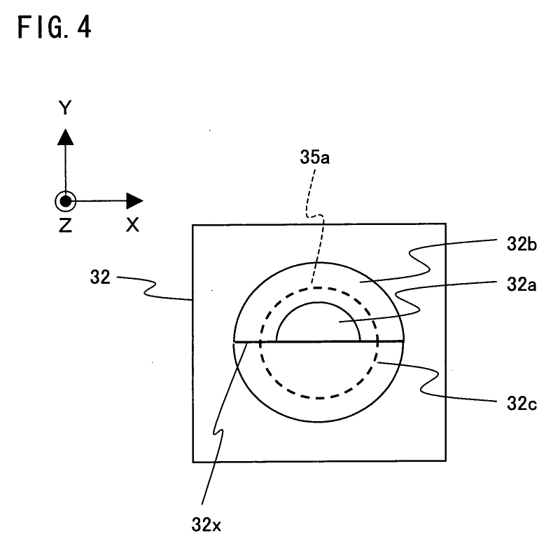

Explained next is the hologram pattern formed on the second polarization diffracting element 32, with reference to FIG. 4. FIG. 4 is a diagram schematically illustrating the hologram pattern of the second polarization light diffracting element 32.

As shown in FIG. 4, the hologram pattern of the second polarization diffracting element 32 is made up of three regions 32a, 32b, and 32c. Specifically, the hologram pattern thereof is made up of (i) the semicircular region 32c, which is one of two portions obtained by dividing the hologram pattern into two along the boundary line 32x extending in the X direction corresponding to the tracking direction; (ii) the inner peripheral region 32a, which is one of two portions obtained by dividing the other semicircular portion into two along the ark-like boundary line; and (iii) the outer peripheral portion 32b, which is the other one of the two portions. Indicated by dotted line in FIG. 4 is a region 35a, on which the returning light beams incident.

Among the regions of the second polarization light diffracting element 32, the region 32b has the smallest grating pitch (maximum diffraction angle). The region 32c has the largest grating pitch (minimum diffraction angle), and the region 32a has a grating pitch falling within a range between the grating pitch of the region 32b and the grating pitch of the region 32c. By using at least one of the ±1st order diffracting light beams passing through the regions 32a and 32b, a spherical aberration error signal (SAES) to be used for correction of the spherical aberration can be detected. Further, a focus error signal to be used for correction of focus point displacement can be detected by using either (i) the single knife edge method using the ±1st order diffraction light beam passing through the region 32c or (ii) the double knife edge method using the ±1st order diffracting light beams passing through the regions 32a, 32b, and 32c.

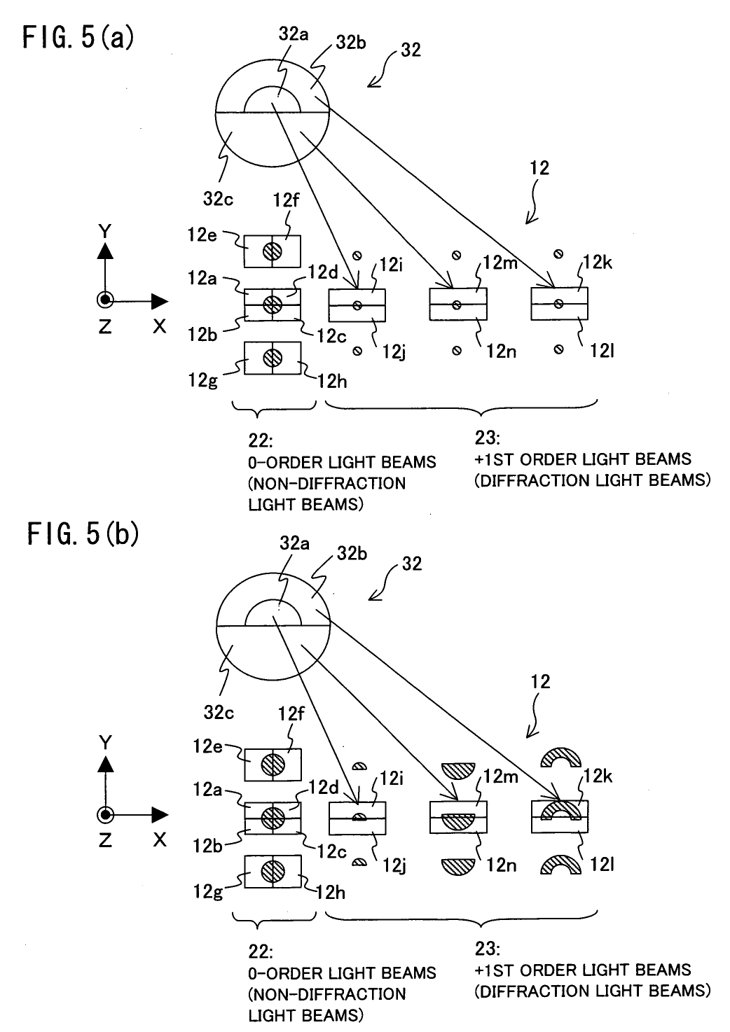

Explained next is a relation between the division pattern of the second polarization light diffracting element 32 and the light receiving pattern of the light receiving element 12, with reference to FIG. 5(a) and FIG. 5(b).

FIG. 5(a) illustrates the light beams which were so reflected by the optical disk 4 as to be received by the light receiving element 12, after being collected and focused on the recording layer 4c of the optical disk 4 shown in FIG. 2. The light beams were collected and focused on the recording layer 4c by adjusting the position of the collimator lens 2 in the optical axis direction such that the no spherical aberration occurs, due to the thickness of the cover layer 4b of the optical disk 4, in the beams collected by the objective lens 3. Further, FIG. 5(a) also illustrates a relation between (i) each of the three regions 32a through 32c (see FIG. 4) of the second polarization light diffracting element 32, and (ii) each of the traveling directions of the 1st order diffraction light beams. Note that: actually, the second polarization light diffracting element 32 is provided such that the central portion of the second polarization light diffracting element 32 corresponds to the central portion of light receiving sections 12a through 12d of the light receiving element 12; however, for ease of explanation, the second polarization light diffracting element 32 is illustrated such that the second polarization light diffracting element 32 is displaced in the Y direction when the optical axis direction is considered as the Z direction.

As shown in FIG. 5(a), the light receiving element 12 is made up of fourteen light receiving sections 12a through 12n. The three light beams 21, obtained by the first polarization light diffracting element 31 and heading for the optical disk 4, are so reflected by the optical disk 4 as to head for the second polarization light diffracting element 32, and are divided by the second polarization light diffracting element 32 into the non-diffraction light beams (0-order light beams) 22 and the diffraction beams (±1st order diffraction light beams) 23. The light receiving sections of the light receiving element 12 receive light beams, necessary for the detection of the RF signal and the servo signal, of the light beams 22 and 23.

Specifically, the second polarization light diffracting element 32 generates the twelve light beams: (i) the three non-diffraction light beams (0-order light beams) 22 and (ii) the nine ±1-order diffraction light beams 23. The non-diffraction light beams (0-order light beams) 23 are so set as to respectively have certain sizes that allow the TES to be detected by using the push-pull method. In the present embodiment, the light receiving element 12 is provided in a slightly inner position with respect to the light collection point of the non-diffraction light beams 22 such that the non-diffraction light beams (0-order diffraction light beams) 22 have certain beam sizes, respectively. Note that the present invention is not limited to this, and the light receiving element 12 may be provided in a slightly outer position with respect to the light collection point of the non-diffraction light beams 22.

As such, the light beams respectively having certain sizes are collected on the boundary portions of the light receiving sections 12a through 12d. Therefore, by carrying out adjustment such that the respective outputs of the four light receiving sections are equal to one another, the position of the light receiving element 12 with respect to the non-diffraction light beams 40 can be adjusted. Thus, the polarization light beam splitter 14 serves as optical element dividing means.

FIG. 5(b) illustrates the light beams which incident on the light receiving element 12, and which are obtained in cases where the objective lens 3 comes closer to the optical disk 4 from the state shown in FIG. 5(a). When the objective lens 3 comes closer to the optical disk 4, the beam sizes of the light beams become larger. However, the light beams do not run off from the light receiving sections.

Explained next is an operation for generating the servo signal, with reference to FIG. 4, FIGS. 5(a) and (b). Note that, in the explanation, the output signals of the light receiving sections 12a through 12n are indicated by symbols “Sa” through “Sn”, respectively.

The RF signal is detected by using the non-diffraction light beams. Specifically, the RF signal (RF) is obtained as follows:
RF=Sa+Sb+Sc+Sd

The tracking error signal (TES1) is detected in accordance with the DPD method, i.e., by comparing phases of the signals Sa through Sd. Specifically, the TES 1 is detected by the following formula in which the result obtained by comparing the phases of the signals Sa and Sd is indicated by A, and in which the result obtained by comparing the phases of the signals Sb and Sc is indicated by B:
TES1=A+B

More specifically, the following principle is used in detecting the tracking error signal (TES1) in accordance with the DPD method. That is, in cases where the light beams collected by the objective lens 3 scan the pit row formed in the recording layer 4c of the optical disk 4, the distribution patterns of the intensities of the reflected light beams are changed according to the positions of the pit row and the foregoing light beam. Specifically, when the light beams scan the center of the pit row, the phase of (Sa+Sc) is the same as the phase of (Sb+Sd). On the other hand, when the light beams scan a position displaced from the center of the pit row, the phase of (Sa+Sc) is reverse to the phase of (Sb+Sd), with the result that a phase difference is obtained therebetween. Thus, by detecting the phase difference between (Sa+Sc) and (Sb+Sd), the tracking error signal is obtained.

In the meanwhile, the tracking error signal (TES2) detected in accordance with the DPP method is expressed in the following formula:
TES2={(Sa+Sb)−(Sc+Sd)}−α{(Se−Sf)+(Sg−Sh)}
where “α” indicates a coefficient optimum for canceling an offset occurring due to (i) the shift of the objective lens and/or (ii) the tilt of the optical disk.

The focus error signal (FES) is detected in accordance with the double knife edge method. That is, the focus error signal is found in accordance with the following formula:
FES=(Sm−Sn)−{(Sk+Si)−(Sl+Sj)}

The spherical aberration error signal (SAES) is detected by using a detection signal generated by the light beams divided by the inner peripheral region 32a and the outer peripheral regions 32b of the second polarization diffracting element 32. That is, the spherical aberration error signal (SAES) is found in accordance with the following formula:
SAES=(Sk−Sl)−β(Si−Sj)
where “β” indicates a coefficient optimum for canceling the offset of the SAES.

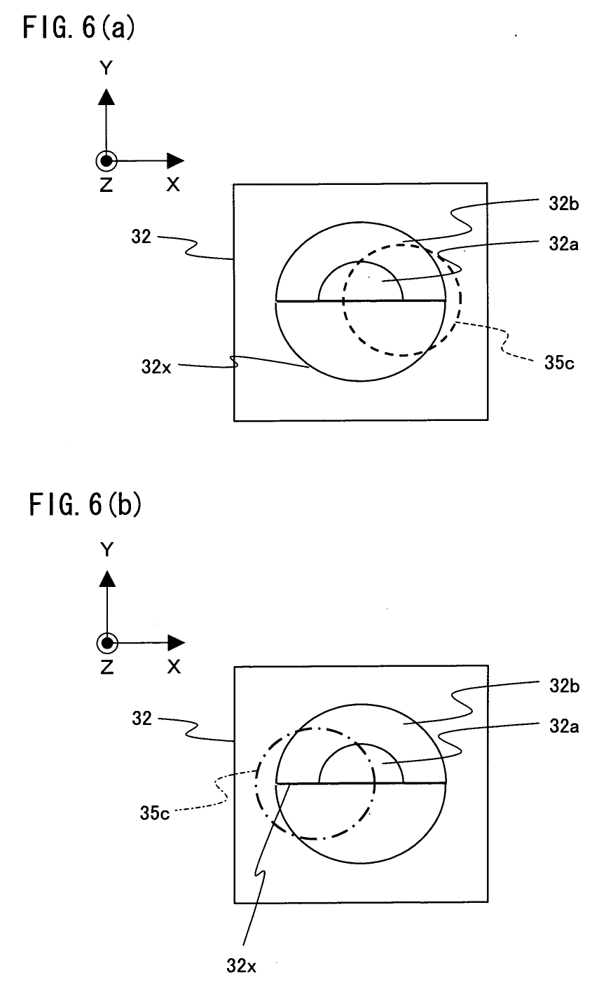

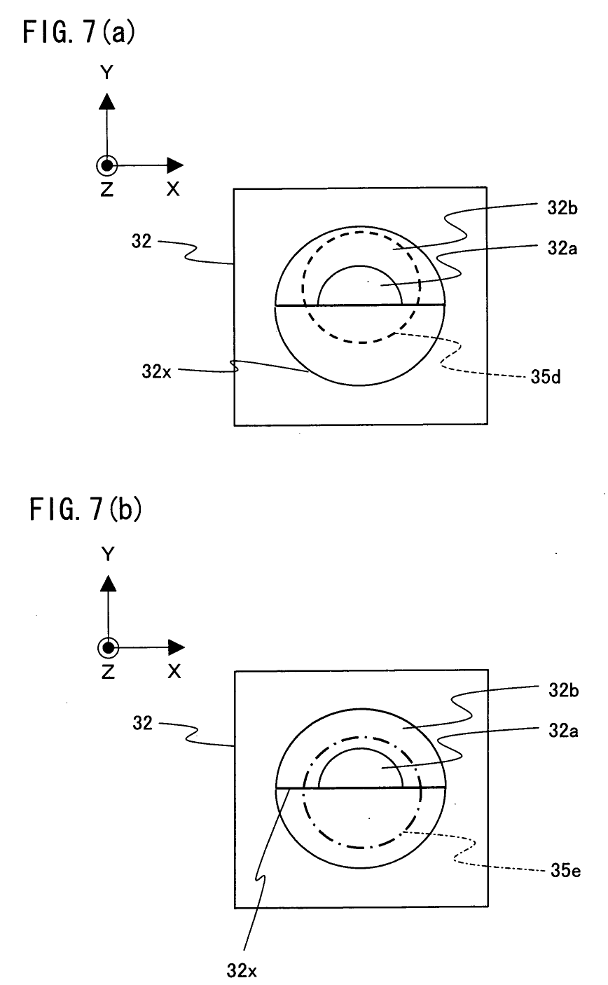

The following explains a method for adjusting respective positions of the light receiving element 12, the polarization light beam splitter 14, and the transparent element 15, with reference to FIG. 6(a), FIG. 6(b), FIG. 7(a), and FIG. 7(b).

Firstly in the above position adjusting method, the position of the polarization light beam splitter 14 is adjusted such that the amounts of light incidenting on the light receiving sections 12a through 12d, i.e., the output signals Sa, Sb, Sc and Sd of the light receiving sections 12a through 12d are equal to each other. Next, the position of the transparent element 15 is adjusted, by rotating the transparent element 15, such that the output signals Si through Sl of the light receiving sections 12i through 121 are generated, thus finishing coarse adjustment of the position of the transparent element 15. Carried out next is fine adjustment of the position of the transparent element 15. The following explains the method for carrying out the fine adjustment of the position of the transparent element 15, with reference to FIG. 6(a), FIG. 6(b), FIG. 7(a), and FIG. 7 (b).

Each of FIG. 6(a) and FIG. 6(b) is a diagram schematically illustrating a case where the beams reflected by the optical disk 4, i.e., the returning light beams pass through a portion (region) displaced from the central portion of the second polarization light diffracting element 32 in the X direction under conditions that the optical axis direction is considered as the Z direction. Specifically, FIG. 6(a) illustrates a case where the returning light beams pass through a portion (region) displaced from the central portion of the second polarization light diffracting element 32 in the +X direction of the X direction. On the other hand, FIG. 6(b) illustrates a case where the returning light beams pass through a portion (region) displaced from the central portion of the second polarization light diffracting element 32 in the −X direction of the X direction. Note that the region (region 35c) indicated by dotted line in each of FIG. 6(a) and FIG. 6(b) is the region of the second polarization diffracting element 32, on which region the returning light beams incident.

Each of FIG. 7(a) and FIG. 7(b) is a diagram schematically illustrating a case where the beams reflected by the optical disk 4, i.e., the returning light beams pass through a portion (region) displaced from the central portion of the second polarization light diffracting element 32 in the Y direction under conditions that the optical axis direction is considered as the Z direction. Specifically, FIG. 7(a) illustrates a case where the returning light beams pass through a portion (region) displaced from the central portion of the second polarization light diffracting element 32 in the +Y direction of the Y direction. On the other hand, FIG. 6(b) illustrates a case where the returning light beams pass through a portion (region) displaced from the central portion of the second polarization light diffracting element 32 in the −Y direction of the Y direction. Note that the region (region 35d) indicated by dotted line in each of FIG. 7(a) and FIG. 7(b) is the region of the second polarization diffracting element 32, on which region the returning light beams incident.

Firstly, consider the case of FIG. 6(a), i.e., the case where the returning light beams coming from the optical disk 4 pass through the portion displaced in the +X direction from the central portion of the second polarization diffracting element 32 under conditions that the optical axis direction is considered as the Z direction. In this case, the following formula is satisfied:
(Si+Sj)−(Sk+Sk)<0

Next, consider the case of FIG. 6(b), i.e., the case where the returning light beams coming from the optical disk 4 pass through the portion displaced in the −X direction from the central portion of the second polarization diffracting element 32 under conditions that the optical axis direction is considered as the Z direction. In this case, the following formula is satisfied:
(Si+Sj)−(Sk+Sl)>0

Therefore, the displacement of the position of the transparent element 15 in the X direction can be adjusted by adjusting the position of the transparent element 15 such that the following formula is satisfied:
(Si+Sj)−(Sk+Sl)=0
Such an adjustment allows the returning light beams to incident on the central portion of the second polarization light diffracting element 32, so that the transparent element 15 is not displaced in the X direction.

In the meanwhile, consider the case of FIG. 7(a), i.e., the case where the returning light beams coming from the optical disk 4 pass through the portion displaced in the +Y direction from the central portion of the second polarization diffracting element 32 under conditions that the optical axis direction is considered as the Z direction. In this case, the following formula is satisfied:
(Si+Sj)+(Sk+Sl)>(Sm+Sn)

On the other hand, consider the case of FIG. 7(b), i.e., the case where the returning light beams coming from the optical disk 4 pass through the portion displaced in the −Y direction from the central portion of the second polarization diffracting element 32 under conditions that the optical axis direction is considered as the Z direction. In this case, the following formula is satisfied:
(Si+Sj)+(Sk+Sl)<(Sm+Sn)

Therefore, the displacement of the position of the transparent element 15 in the Y direction can be adjusted by adjusting the position of the transparent element 15 such that the following formula is satisfied:
(Si+Sj)+(Sk+Sl)−(Sm+Sn)=0
Such an adjustment allows the returning light beams to incident on the central portion of the second polarization light diffracting element 32, so that the position of the transparent element 15 is not displaced in the X direction.

In this way, the fine adjustment of the position of the transparent element 15 is finished by eliminating the displacement of the transparent element 15 in the X and Y directions.

Further, the first polarization light diffracting element 31 and the second polarization light diffracting element 32 are accurately positioned at the mask precision on the transparent element 15 having the two surfaces parallel to each other, and can be manufactured in one piece. Therefore, by carrying out the position adjustment of the second polarization light diffracting element 32 for the sake of acquiring a predetermined servo signal, the position adjustment of the first polarization light diffracting element 31 is carried out at the same time. In other words, an adjustment in assembling the optical integrated unit 1 becomes easy, and precision in the adjustment is improved.

Further, the present embodiment makes it possible that: the aforementioned position adjusting method allows simplification of the processes of assembling the optical integrated unit 1, with the result that a low cost optical pickup can be provided.

In the present embodiment, the light intensity distribution of the light beam 20 emitted from the semiconductor laser 11 is caused to be flat by the first polarization light diffracting element 31.

This makes it possible that a fine spot is formed on the optical disk 4, with the result that the optical pickup has an improved temporal resolution with respect to a resolution signal. This allows improvement of an S/N ratio of the reproduction signal.

Further, the optical integrated unit 1 is a structure, which includes the ½ wavelength plate 13, the ¼ wavelength plate 16, and the polarization light diffracting elements (the first polarization light diffracting element 31 and the second polarization light diffracting element 32), and which uses the polarization light beams. Such a structure allows high utilization efficiency of the light beams. This allows realization of a stable recording/reproducing property even when the power of the semiconductor laser is not increased.

Further, the present embodiment uses the polarization light beam splitter 4 having the two reflecting surfaces parallel to each other.

With this, the second polarization light diffracting element 32 is provided in the side opposite to the semiconductor laser 11 and the light receiving element 12, and the length of the light path from the semiconductor laser 11 to each of the diffracting elements (the first polarization light diffracting element 31 and the second polarization light diffracting element 32) becomes longer, and the length of the light path from the light receiving element 12 to each of the diffracting elements (the first polarization light diffracting element 31 and the second polarization light diffracting element 32) becomes longer.

Accordingly, even when each of the diffracting elements (the first polarization light diffracting element 31 and the second polarization light diffracting element 32) is so set as to have a small diffraction angle, the diffracted light beams (returning light beams) are finely separated in the light receiving element 12. As such, the 0-order diffraction light beams and the +1st order diffraction light beams are allowed to be separated in the light receiving element with such a small diffraction angle, so that both the non-diffraction light beams and the diffraction light beams are detected. With this, high-speed signals can be detected with the use of the non-diffracting light beams thus detected, and the servo signal can be detected with the use of the diffraction light beams thus detected. Examples of the high speed signals include: the RF signal and the TES signal to be detected in accordance with the DPD method.

Further, the hermetically sealed semiconductor package is used, so that the semiconductor laser is not exposed to the outside air. With this, the property of the semiconductor laser is less likely to be deteriorated.

### Embodiment 2

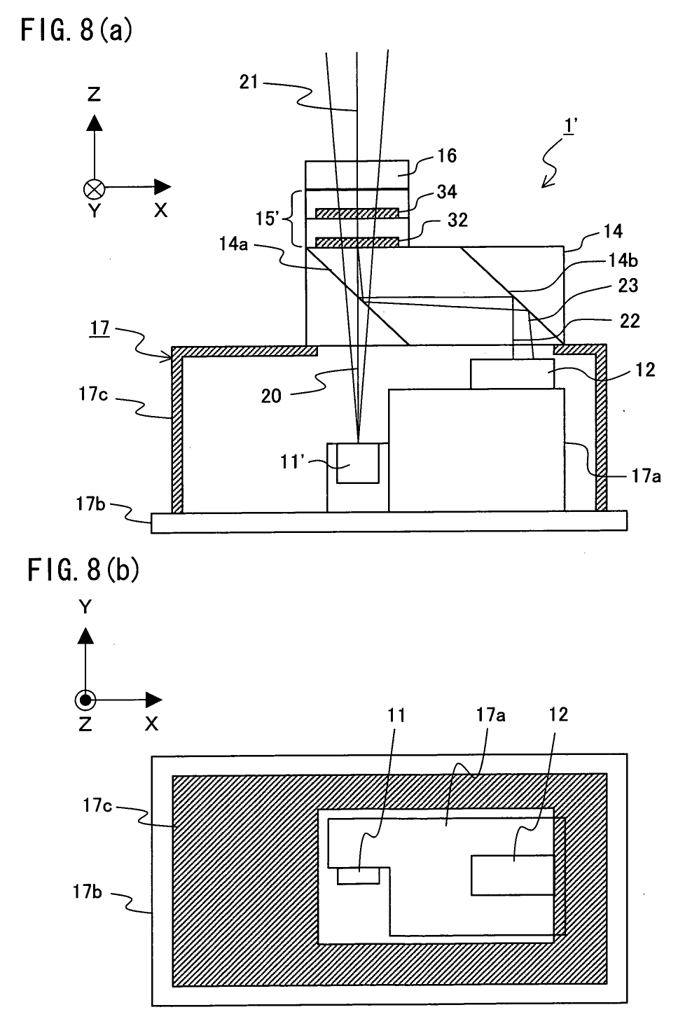

The following description deals with another embodiment of the present invention with reference to FIG. 8(a) and FIG. 8(b). Explained in the present embodiment are differences from Embodiment 1. Therefore, for ease of explanation, materials having the equivalent functions as those shown in the drawings pertaining to Embodiment 1 will be given the same reference symbols, and explanation thereof will be omitted here.

Each of FIG. 8(a) and FIG. 8(b) is a diagram schematically illustrating a structure of an optical integrated unit of Embodiment 2 of the present invention. FIG. 8(a) is a side view illustrating the optical integrated unit when viewed in the Y direction under conditions that the optical direction is considered as the Z direction shown in FIG. 8(a). FIG. 8(b) is an overhead view illustrating the optical integrated unit when viewed in the optical axis direction (Z direction) shown in FIG. 8(a), i.e., when viewed from the side of the window portion 17d of the cap 17c.

The differences between the optical integrated unit of the present embodiment and the optical integrated unit of Embodiment 1 lie in the following points (1) through (3): (1) the direction in which a semiconductor laser (light source) of the optical integrated unit of the present embodiment is installed is different from the direction in which the semiconductor laser of the optical integrated unit of Embodiment 1 is installed; (2) no ½ wavelength plate 13 is provided in the optical integrated unit of the present embodiment; and (3) the hologram pattern of a first polarization light diffracting element 34 shown in FIG. 8(a) is different from that in Embodiment 1.

In Embodiment 1, the semiconductor laser 11 shown in FIG. 1 emits the linear polarization light including a component polarized in the Y direction (S polarization light). On the other hand, in the present embodiment, the semiconductor laser 11′ shown in FIG. 8 emits linear polarization light including a component polarized in the X direction (P polarization light).

Therefore, as shown in FIG. 8(a), when entering the polarization light beam splitter 14, such a P polarization light beam 20′ emitted from the semiconductor laser 11′ is never reflected by the PBS surface 14a of the polarization light beam splitter 14. So, the optical integrated unit 1′ of the present embodiment is such a structure that does not need to include the ½ wavelength plate 13, unlike the optical integrated unit of Embodiment 1.

Further, the light beam 20′ emitted from the semiconductor laser 11′ is an elliptic light flux whose long axis corresponds to the Y direction, and whose short axis corresponds to the X direction. As described in Embodiment 1, the light intensity distribution of the elliptic light flux in the short axis direction is not flat. In order to render the light intensity distribution in the short axis direction flat, a light intensity distribution correction needs to be carried out in the short axis direction.

Specifically, the first light diffracting element 34 shown in FIG. 8(a) and FIG. 8(b) is so arranged as to correct the light intensity distribution in the X direction that is the short axis direction of the light beam 20′. More specifically, the first polarization light diffracting element 34 needs to be provided such that the grating groove widths w are changed in the Y axis direction shown in FIG. 8(a) and FIG. 8(b). On this account, the light beam emitted from the semiconductor laser 11′ has a flat light intensity distribution in the X direction that is the short axis direction of the light beam 20′.

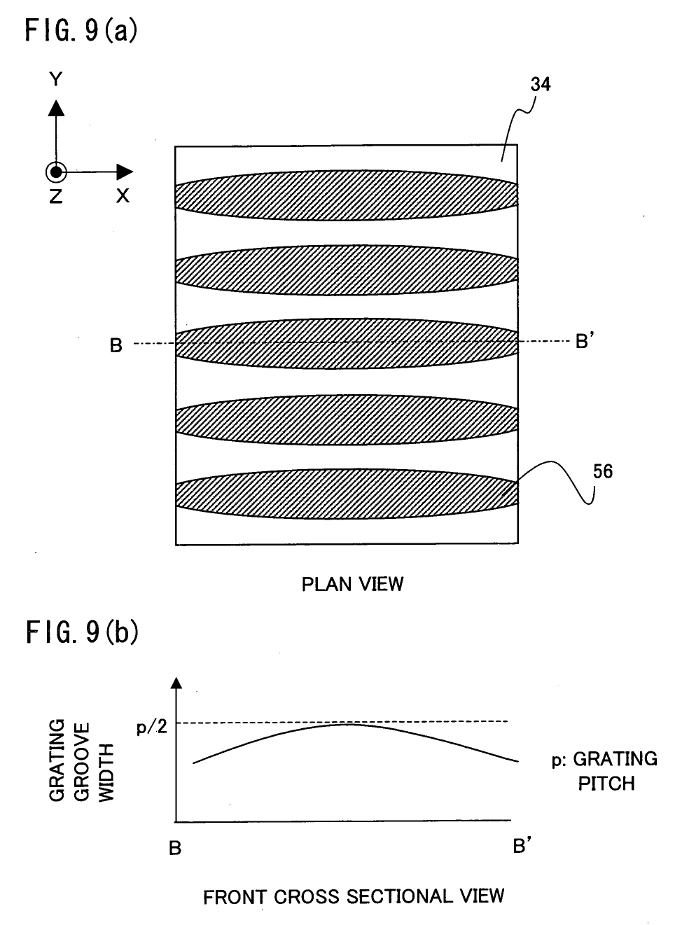

The following explains one example of the hologram pattern of the first polarization diffracting element 34 of the optical integrated unit 1′ with reference to FIG. 9(a) and FIG. 9(b). Each of FIG. 9(a) and FIG. 9(b) illustrates one example of the hologram pattern of the first polarization diffracting element 34 formed on the surface of the transparent element 15′. FIG. 9(a) is a plan view and FIG. 9(b) is a cross sectional view taken along line B-B′.

As shown in FIG. 9(a), grating grooves 56 are provided in the first polarization diffracting element 34. The grating grooves 56 have grating groove widths (i) that are closer to the half of the length of the grating pitch as closer to the central portion of the first polarization diffracting element 34 in the X direction, and that (ii) are smaller than the half of the length of the grating pitch as further from the central portion toward the peripheral portion of the first polarization diffracting element 34 in the X direction. With this, the light intensity distribution of the received laser light flux in the X direction becomes closer to a flat light intensity distribution.

Further, also in the optical integrated unit 1′ of the present embodiment, the liquid crystal is provided between the first polarization light diffracting element 34 and the second polarization light diffracting element 32. This allows realization of the selectivity that depends on the polarization direction.

Further, as is the case with the first polarization light diffracting element 31 of the optical integrated unit of Embodiment 1, the first polarization light diffracting element 34 has rise portions (i.e., diffraction grating) each designed to have a refractive index coinciding with the extraordinary index (extraordinary refractive index) of the liquid crystal. On the other hand, as is the case with the second polarization light diffracting element 32 of the optical integrated unit of Embodiment 1, the second polarization light diffracting element 32 has rise portions (i.e., diffraction grating) each designed to have a refractive index coinciding with the ordinary index (ordinary refractive index) of the liquid crystal. This attains the selectivity that depends on the polarization direction, as is the case with Embodiment 1.

As described above, the semiconductor laser 11′ emits the P polarization light beam 20′, so that no ½ wavelength plate is provided. This makes it possible to reduce the number of parts in the optical integrated unit, as compared with the number of parts in the optical integrated unit of Embodiment 1, and to provide a small and inexpensive optical pickup.

In the present embodiment, the light intensity distribution of the light beam 20′ emitted from the semiconductor laser 11′ is caused to be flat by the first polarization light diffracting element 34. This makes it possible that a fine spot is formed on the optical disk 4, and allows the optical pickup to have an improved temporal resolution with respect to a resolution signal. This allows improvement of an S/N ratio of the reproduction signal.

### Embodiment 3

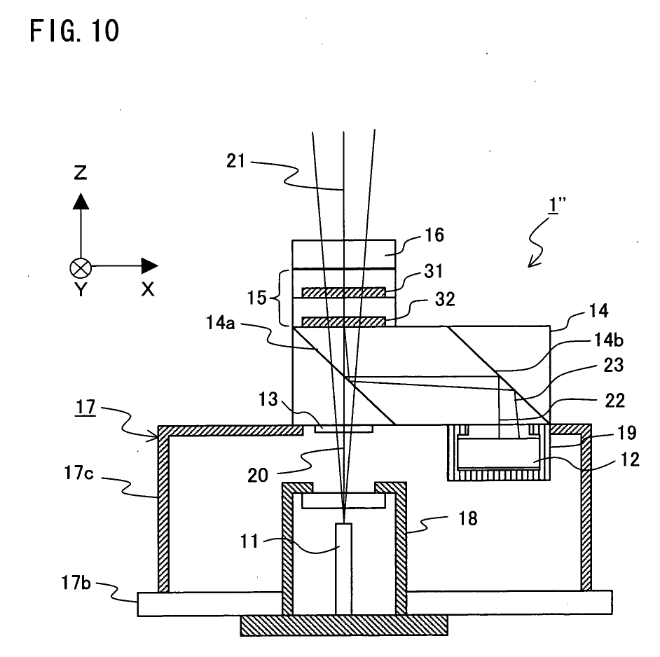

The following description deals with still another embodiment of the present invention with reference to FIG. 10. Explained in the present embodiment are differences from Embodiment 1. Therefore, for ease of explanation, materials having the equivalent functions as those shown in the drawings pertaining to Embodiment 1 will be given the same reference symbols, and explanation thereof will be omitted here.

FIG. 10 is a side view illustrating an optical integrated unit of Embodiment 3 of the present invention when viewed in the Y direction under conditions that the optical direction is considered as the Z direction illustrated in FIG. 10. The optical integrated unit of the present embodiment is different from the optical integrated unit of Embodiment 1 in terms of respective structures of the semiconductor laser 11 and the light receiving element 12.

Specifically, in Embodiment 1, the semiconductor laser 11 and the light receiving element 12 are provided in the package 17. On the other hand, in the optical integrated unit 1″, the semiconductor laser 11 and the light receiving element 12 are respectively provided in individual packages 18 and 19 as shown in FIG. 10. Specifically, as shown in FIG. 10, the semiconductor laser 11 and the light receiving element 12 in the present embodiment are respectively provided in the individual packages 18 and 19, and the packages 18 and 19 thus respectively containing the semiconductor laser 11 and the light receiving element 12 are integrated in a package 17 identical to the package 17 of Embodiment 1.

This makes it possible to surely seal the semiconductor laser 11 and the light receiving element 12, so that respective properties of the semiconductor 11 and the light receiving element 12 are surely prevented from being deteriorated.

Accordingly, the package 17 does not need to be sealed. With this, the polarization light beam splitter 14 does not need to have such a size that completely covers the window portion 17d of the package 17, so that the part can be downsized. This allows downsizing, weight saving, and cost reduction of the integrated unit.

Further, the above arrangement allows the semiconductor laser 11 and the light receiving element 12 to be handled with ease. This makes it difficult that breakdown occurs in using the optical integrated unit, and makes it easy to repair the semiconductor laser 11 and the light receiving element 12 if the semiconductor laser 11 and the light receiving element 12 are broken.

Further, the position of the semiconductor laser 11 can be adjusted with respect to each of the positions of the polarization light beam splitter 14 and the light receiving element 12, so that an error in assembling the optical integrated unit can be eliminated and the returning light beams therefore surely incident on the light receiving element 12.

### Embodiment 4

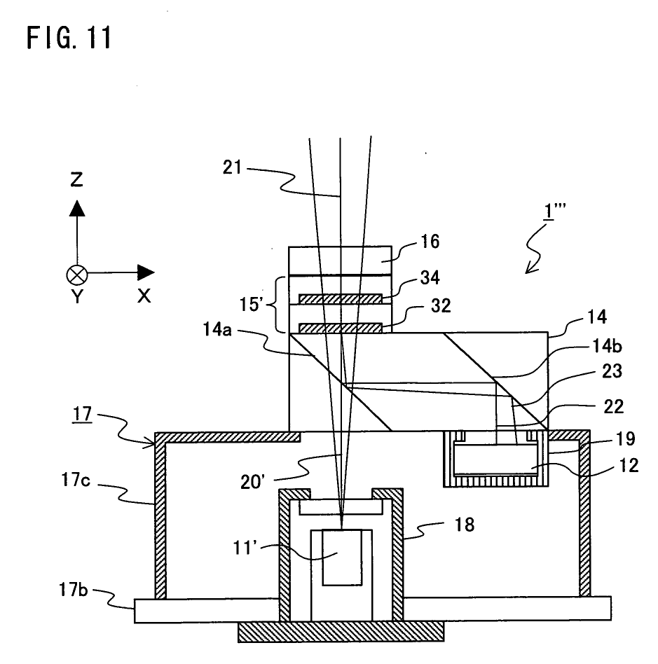

The following description deals with yet another embodiment of the present invention with reference to FIG. 11. Explained in the present embodiment are differences from the aforementioned embodiments. Therefore, for ease of explanation, materials having the equivalent functions as those shown in the drawings pertaining to the aforementioned embodiments will be given the same reference symbols, and explanation thereof will be omitted here.

FIG. 11 is a side view illustrating an optical integrated unit 1 of Embodiment 4 of the present invention when viewed in the Y direction under conditions that the optical direction is considered as the Z direction illustrated in FIG. 11. The optical integrated unit of the present embodiment is different from the optical integrated unit of Embodiment 3 in terms of the direction in which the semiconductor laser 11 (light source) is installed.

The optical integrated unit 1 ′″ includes a semiconductor laser 11′ which emits P polarization light beam 20′. For this reason, no ½ wavelength plate 13 is provided in the optical integrated unit 1′″. This makes it possible to reduce the number of parts in the optical integrated unit, and to provide a small and inexpensive optical pickup.

Further, the optical integrated unit of the present embodiment has a first polarization light diffracting element 34 (see FIG. 11) whose hologram pattern is different from that of Embodiment 1 but is identical to that of Embodiment 2.

Therefore, as shown in FIG. 11, the light intensity distribution, in the X direction shown in FIG. 11, of the light beam 20′ emitted from the semiconductor laser 11′ of the optical integrated unit 1′″ of the present embodiment is caused to be flat by the first polarization light diffracting element 34. This makes it possible that a fine spot is formed on the optical disk 4, and allows the optical pickup to have an improved temporal resolution with respect to a resolution signal. This allows improvement of an S/N ratio of the reproduction signal.

As is the case with Embodiment 3, the optical integrated unit 1 of the present embodiment includes the semiconductor laser 11 and the light receiving element 12 respectively contained in the packages 18 and 19. In other words, as shown in FIG. 10, the semiconductor laser 11 and the light receiving element 12 in the present embodiment are respectively provided in the individual packages 18 and 19, and the packages 18 and 19 thus respectively containing the semiconductor laser, 11 and the light receiving element 12 are integrated in a package 17 identical to the package 17 of Embodiment 1.

In addition to the effect exhibited in Embodiment 3, the optical integrated unit 1′″ of the present embodiment allows reduction of the number of parts, with the result that a small and inexpensive optical pickup can be provided.

### Embodiment 5

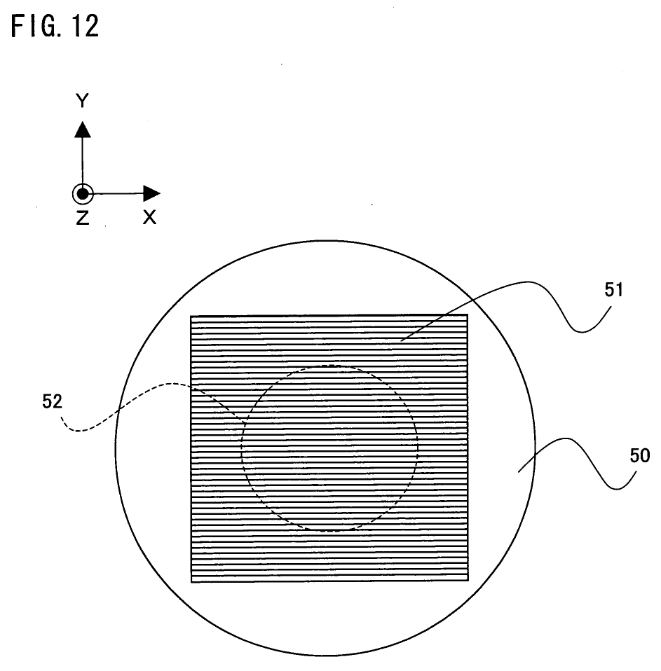

The following description deals with still another embodiment of the present invention with reference to FIG. 12. Explained in the present embodiment are differences from Embodiment 1. Therefore, for ease of explanation, materials having the equivalent functions as those shown in the drawings pertaining to the Embodiment 1 will be given the same reference symbols, and explanation thereof will be omitted here.

An optical integrated unit of the present embodiment includes a first polarization light diffracting element whose feature lies in that: the first polarization light diffracting element has a hologram region which is smaller than the size of the light flux of the light beam emitted from the semiconductor laser and than the size of the light flux of the light beams collected on the optical disk 4, unlike the first polarization light diffracting element of each of Embodiments 1 through 4.

Explained next is the hologram region of the first polarization light diffracting element provided in the optical integrated unit of the present embodiment, with reference to FIG. 12. FIG. 12 is a diagram schematically illustrating a relation among (i) the light beam to be diffracted by the hologram region, (ii) the size of the light flux of the light beam emitted from the semiconductor laser, and (iii) the size of the light flux of the light beams to be collected on the optical disk.

A region 50 shown in FIG. 12 indicates the light flux of the light beams, which are obtained from the light beam emitted from the semiconductor laser 11 and which has passed through the collimator lens 2 shown in FIG. 2. Here, as shown in FIG. 2, the light beam emitted from the semiconductor laser 11 enters the transparent element 15 and is diffracted by the first polarization diffracting element 31 into the light beams when passing therethrough, and the light beams thus diffracted enter the collimator lens 2.

The light beam emitted from the semiconductor laser 11 enters the following regions (a) and (b) of the first polarization light diffracting element 31: (a) a region in which grating grooves are provided, and (b) a region in which no grating groove is provided. Thus, the passing light (the light beam passing through the first polarization diffracting element 31) has portions respectively passing through the regions (a) and (b), and the light intensities of the portions of the passing light become different from each other. See FIG. 12. A region 51 in the light beam emitted from the semiconductor laser 11 is the region to be diffracted by the first polarization diffracting element 31.

Further, as shown in FIG. 2, the light beams go out of the collimator lens 2, and are collected on the optical disk 4 by the objective lens 3. A region 52 shown in FIG. 12 represents the light flux of the light beams, which are collected on the optical disk by the objective lens and which are used for recording and/or reproduction of the information.

In general, the optical pickup is set such that the region 52 is larger than the effective diameter of the objective lens, because the objective lens is shifted in the radial direction (X direction) in response to tracking control. Further, coarse adjustment of the transparent element 15 is carried out as follows. That is, the position of the transparent element 15 is adjusted such that the region 51 diffracted by the first polarization light diffracting element 31 is positioned in the center of the region 50 that is the light flux of the light beam emitted from the semiconductor laser 11. Further, fine adjustment of the position of the transparent element 15 is carried out in accordance with the method described in Embodiment 1. As such, the position of the transparent element 15 can be adjusted with ease.

Therefore, the first polarization light diffracting element needs to be so manufactured as to be smaller than the region 50 of the light beam incidenting on the surface of the first polarization light diffracting element, but as to be larger than the size of the region 52 to be used for the recording and/or reproduction of information.

Each of Embodiments 1 through 5 assumes the structure in which the three beams are generated by the first polarization light diffracting element. However, the present invention is not limited to such a structure, and the first polarization light diffracting element of the optical integrated unit of the present invention is applicable to an optical integrated unit using one beam instead of the three beams for use in generating the TES.

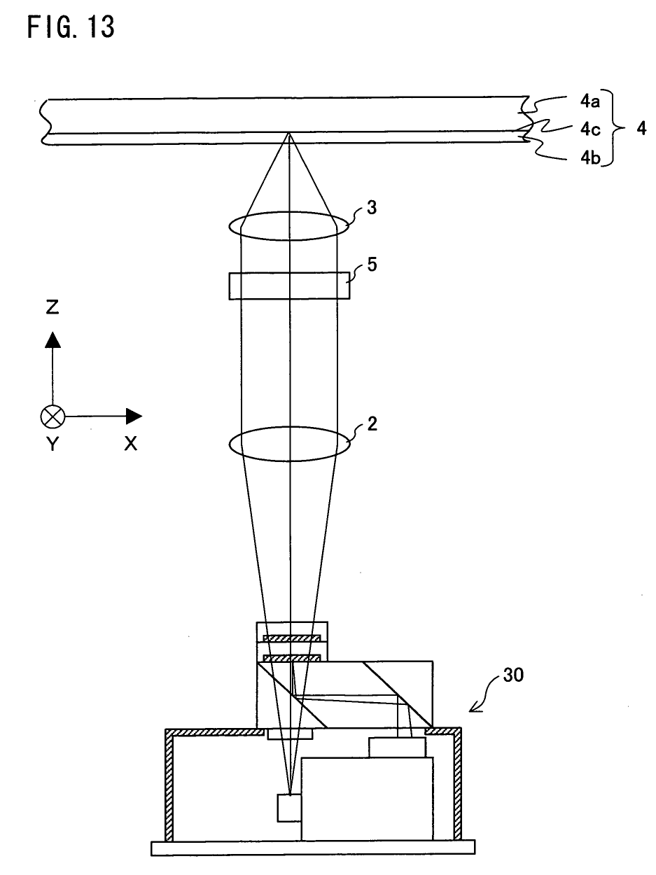

Note that the optical pickup of the present invention may have such a structure that an optical integrated unit 30 in which no ¼ wavelength plate 16 is provided is combined with an external ¼ wavelength plate 5 as shown in FIG. 13.

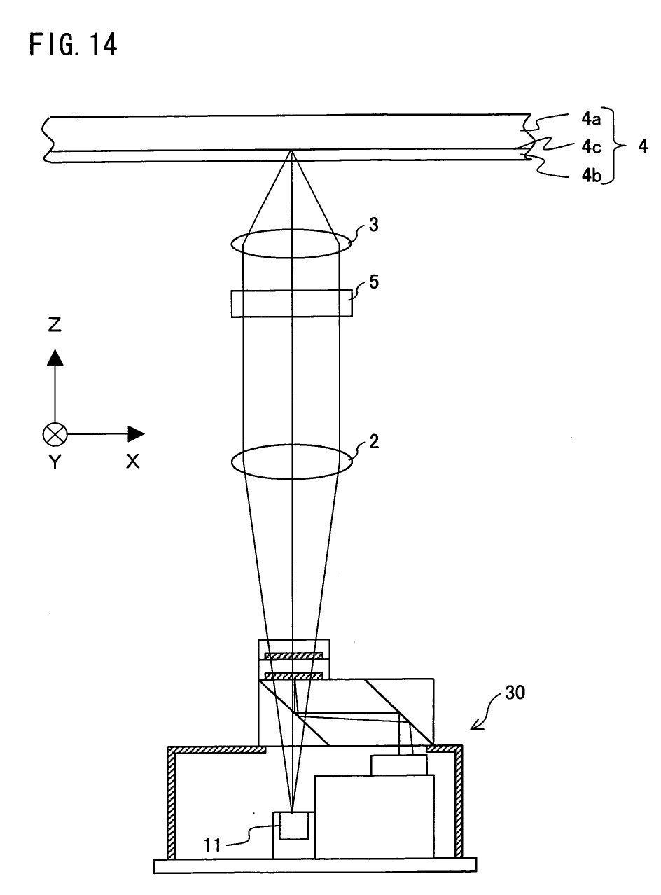

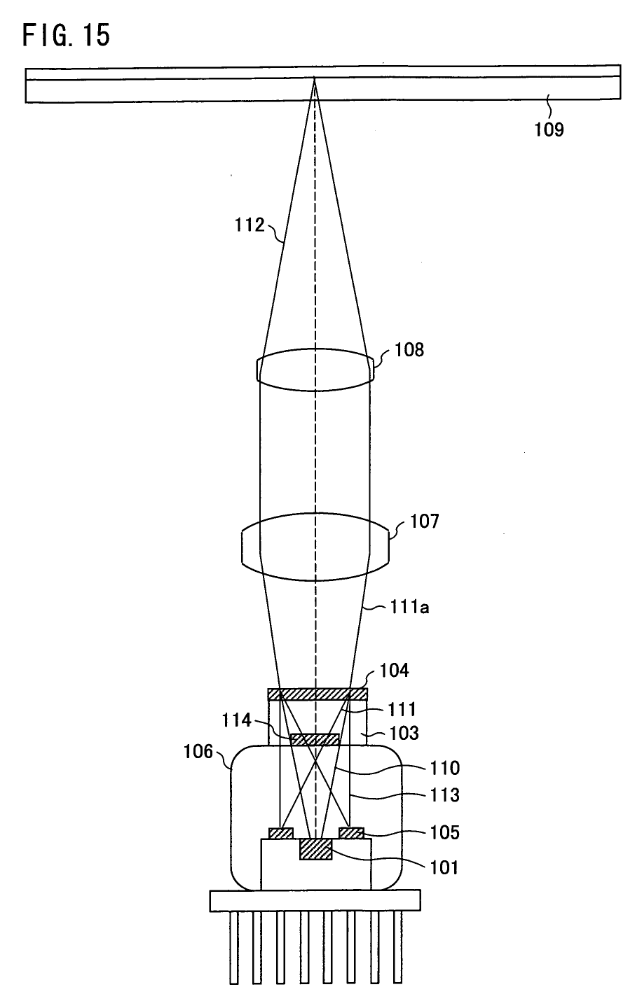

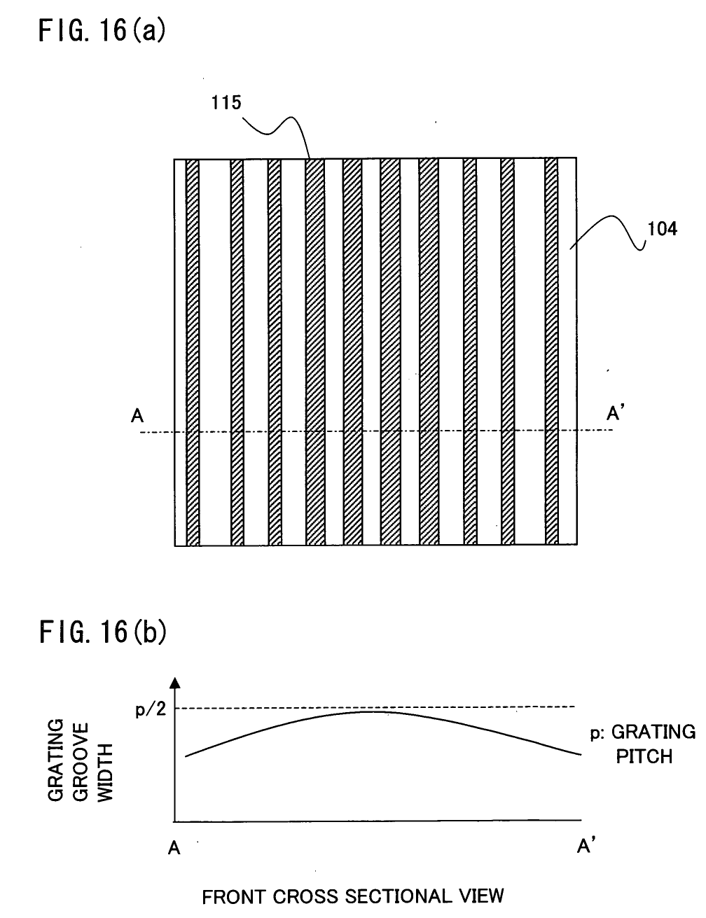

Further, the optical pickup of the present invention may have such a structure that: the semiconductor laser 11 (light source) of the structure shown in FIG. 13 is installed in a different direction, and the hologram pattern of the first polarization diffraction element is changed to the hologram pattern of the first polarization diffraction element 34 shown in FIG. 9, and no ½ wavelength plate 13 is provided. In other words, the optical pickup of the present invention may have such a structure that is described in FIG. 14.

Further, the optical integrated unit 1 of Embodiment 1 has such a structure that the second polarization light diffracting element 32 is provided between the first polarization light diffracting element 31 and the semiconductor laser 11; however, the optical integrated unit of the present invention is not limited to this, and may have such a structure inverse to the structure of the optical integrated unit 1 of Embodiment 1, i.e., may have such a structure that the first diffracting element 31 is provided between the second polarization light diffracting element 32 and the semiconductor laser 11.

Further, the optical integrated unit 1′ of Embodiment 2 has such a structure that the second polarization light diffracting element 32 is provided between the first polarization light diffracting element 31 and the semiconductor laser 11 as shown in FIG. 8; however, the optical integrated unit of the present invention is not limited to this, and may have such a structure inverse to the structure of the optical integrated unit of Embodiment 2, i.e., may have such a structure that the first diffracting element 31 shown in FIG. 8 is provided between the second polarization light diffracting element 32 and the semiconductor laser 11.

Further, it is possible to express the optical integrated unit of the present invention as a structure, including (i) a first polarization light diffracting element for diffracting emission light emitted from a light source; (ii) a second polarization light diffracting grating provided so as to divide returning light coming from an optical information recording medium, into (a) a light flux existing in a vicinity of a central portion of a light flux of the returning light and (b) a light flux existing in a vicinity of a peripheral portion of the light flux of the returning light; (iii) light splitting means for guiding the returning light to a light receiving element; and (iv) the light receiving element for detecting the returning light, the first polarization light diffracting element having (a) a region through which a light flux existing in a vicinity of a central portion of a light flux of the emission light passes, and (b) a region through which a light flux existing in a vicinity of a peripheral portion of a light flux of the emission light passes, at least either grating groove widths or grating groove depths in the regions of the first polarization light diffracting element being different from each other, the first polarization light diffracting element and second polarization light diffracting element being respectively provided face to face on surfaces of a transparent element.

Further, an optical integrated unit of the present invention includes (i) a first polarization light diffracting element for diffracting emission light emitted from a light source; (ii) a second polarization light diffracting grating provided so as to divide returning light coming from an optical information recording medium, into (a) a light flux existing in a vicinity of a central portion of a light flux of the returning light and (b) a light flux existing in a vicinity of a peripheral portion of the light flux of the returning light; (iii) light splitting means for guiding the returning light to a light receiving element; and (iv) the light receiving element for detecting the returning light, the first polarization light diffracting element having (a) a region through which a light flux existing in a vicinity of a central portion of a light flux of the emission light passes, and (b) a region through which a light flux existing in a vicinity of a peripheral portion of a light flux of the emission light passes, at least either grating groove widths or grating groove depths in the regions of the first polarization light diffracting element being different from each other, the first polarization light diffracting element including a first hologram region for dividing the emission light into at least three beams, the second polarization light diffracting element including a second hologram region for dividing the returning light coming from the optical information recording medium, into non-diffraction light and diffraction light, the first polarization light diffracting element having a side which is opposite to the light source and on which a ¼ wavelength plate is provided.

In the structure, it is preferable that the light splitting means be a polarization light beam splitter at least having reflective surfaces parallel to each other.

According to such a structure, the first polarization light diffracting element having the light intensity distribution correcting function, and the second polarization light diffracting element for dividing the returning light are used, so that the light intensity distribution of the emission light becomes flat. On this account, a fine spot can be formed on the optical disk, with the result that the optical pickup has an improved temporal resolution with respect to a reproduction signal and an S/N ratio of the reproduction signal is improved. Further, the structure includes the ½ wavelength plate, the ¼ wavelength plate, and the polarization light diffracting elements, and uses the polarization light as such, so that the emission light emitted from the light source is diffracted only by the first polarization light diffracting element and is never diffracted by the second polarization light diffracting element. In contrast, the returning light coming from the optical information recording medium is diffracted only by the second polarization diffracting element, and is not diffracted by the first polarization diffracting element. Therefore, light utilization efficiency is high, so that a semiconductor laser having a strong power does not need to be used. This makes it possible to provide an inexpensive optical pickup having a stable property.

Further, the polarization light beam splitter having the two reflective surfaces parallel to each other is used, so that the second polarization light diffracting element can be provided in the side opposite to the side on which the light source and the light receiving element are provided. On this account, the length of a light path extending from the light source to the diffracting element becomes longer, and the length of a light path extending from the light receiving element to the diffracting element becomes longer. Accordingly, the light beams can be separated in the light receiving element, even when the diffraction angle of the diffracting element is set small. Thus, such a small diffraction angle allows the 0-order diffraction light beams and +1st order diffraction light beams to be separated from one another, with the result that the non-diffraction light and the diffraction light can be detected, and the non-diffraction light thus detected is used for detection of high-speed signals such as (i) an RF signal and (ii) a TES signal to be detected in accordance with the DPD method, and the diffraction light thus detected is used for detection of a servo signal.

Further, a hermetically sealed semiconductor package is used, so that the semiconductor laser is not exposed to outside air. Therefore, a property of the semiconductor laser is less likely to be deteriorated.

Further, the first polarization light diffracting element and the second polarization light diffracting element can be manufactured in one piece after precisely registering the positions thereof at the mask precision on the transparent element having the two surfaces parallel to each other. Therefore, by carrying out the position adjustment of the second polarization light diffracting element such that a predetermined servo signal will be acquired, the position adjustment of the first polarization light diffracting element is done simultaneously. With this, adjustment in assembling the optical integrated unit becomes easy and adjustment precision becomes higher. Further, the position of the second polarization light diffracting element can be adjusted with respect to the respective positions of the light receiving element and the light splitting means. Therefore, by carrying out the position adjustment in accordance with the above adjustment method, assembly processes can be simplified. This makes it possible to provide a low cost optical pickup.

Further, the first polarization diffracting element is so formed as to be smaller than the size of the light flux of the emission light in the first polarization light diffracting element, but as to be larger than the size of the light flux collected on the optical information recording medium. On this account, the assembly processes can be more simplified, so that a low cost optical pickup can be provided.

The present invention is not limited to the description of the embodiments above, but may be altered by a skilled person within the scope of the claims. An embodiment based on a proper combination of technical means disclosed in different embodiments is encompassed in the technical scope of the present invention.

As described above, an optical integrated unit of the present invention includes: (i) diffracting means for diffracting the first polarization component light in a direction toward the optical information recording medium, and for diffracting the second polarization component light in a direction toward the light receiving element such that decrease of light intensity of the light beam is smaller as further from a vicinity of an optical axis of the light beam toward a peripheral portion of the light beam; and (ii) polarization component converting means, which is provided in a light path between the light source and the diffracting means, and which converts the returning light into second polarization component light.

As such, the above structure uses the polarization light, and includes (i) the diffracting means for diffracting the first polarization light in the direction toward the optical information recording medium, and (ii) the polarization component converting means for converting the returning light into the second polarization component light. Such a structure allows the light receiving element to efficiently receive the returning light coming from the optical information recording medium. Therefore, the light beam diffracted by the first polarization diffracting element can be wholly used for detection of signals, so that light utilization efficiency becomes very high.

Therefore, in cases where, e.g., a semiconductor laser is used as the light source, a semiconductor laser having a strong power does not need to be used. This makes it possible to provide a low cost optical pickup having a stable recording/reproducing performance.

The diffracting means diffracts the first polarization component light in the direction toward the optical information recording medium such that the decrease of the light intensity of the light beam is larger as further from the vicinity of the optical axis of the light beam toward the peripheral portion thereof. This makes it possible to form a finer spot of the light beam on the optical information recording medium, with the result that a temporal resolution with respect to a reproduction signal is improved and an S/N ratio of the reproduction signal is improved.

Further, as described above, an optical pickup of the present invention includes the above optical integrated unit. This allows minimization of decrease of the light utilization efficiency, so that more stable recording/reproducing performance can be realized.

Note that each of the “first polarization component light” and the “second polarization component light” is not particularly limited as long as each of the first polarization component light and the second polarization component light has a polarization component allowing realization of the aforementioned structure “using the polarization light”; however, it is particularly preferable that each of them be linear polarization light. In cases where each of the first polarization component light and the second polarization component light is linear polarization light, it is preferable that the first polarization component and the second polarization component be orthogonal to each other. In other words, in cases where “the first polarization component light” is linear polarization light polarized in a predetermined direction, it is preferable that the “second polarization component light” is linear polarization light polarized in the direction perpendicular to the predetermined direction.

Further, it is preferable to arrange the optical integrated unit of the present invention such that: the polarization component converting means is a ¼ wavelength plate.

According to the above structure, in cases where each of the first polarization component light and the second polarization component light is the linear polarization light, only linear polarization light polarized in a predetermined direction is diffracted by the diffracting means in the direction toward the optical information recording medium, and then enters the ¼ wavelength plate. The ¼ wavelength plate causes the linear polarization light to be circular polarization light, and the circular polarization light thus obtained heads for the optical information recording medium. This makes it difficult that, e.g., generation of an RF signal is influenced by double refraction of the substrate of the information recording medium.

Further, the returning light, i.e., the light reflected by the optical information recording medium passes through the ¼ wavelength plate, with the result that the returning light becomes linear polarization light polarized in the direction orthogonal to the direction in which the foregoing linear polarization light is polarized. Therefore, the retuning light thus having become such linear polarization light can be wholly diffracted by the diffracting means in the direction toward the light receiving element. This makes it possible to further improve the utilization efficiency of the returning light.

Further, it is preferable to arrange the optical integrated unit of the present invention such that: the diffracting means includes (i) a first polarization light diffracting element, which diffracts the first polarization component light but which allows the second polarization component light to pass therethrough; and (ii) a second polarization light diffracting element, which diffracts the second polarization component light but which allows the first polarization component light to pass therethrough.

According to the above structure, the first polarization component light of the light beam emitted from the light source is diffracted by the first polarization light diffracting element in the direction toward the optical information recording medium, but the second polarization component light is never diffracted but passes through the first polarization light diffracting element.

The light beam having passed through the first and second polarization light diffracting elements is so reflected by the optical information recording medium as to be the returning light. Then, the returning light passes through the polarization component converting means, with the result that the returning light becomes the second polarization component light. Then the second polarization component light enters the diffracting means. The returning light including the second polarization component light is never diffracted by the first polarization light diffracting element and passes therethrough. Then, the returning light is diffracted by the second polarization diffracting element in the direction toward the light receiving element.

Therefore, the structure including the first and second polarization light diffracting elements makes it possible to (i) diffract, in the direction toward the optical information recording medium, the first polarization component light of the light beam emitted from the light source, and (ii) diffract, in the direction toward the light receiving element, the second polarization component light of the returning light, i.e., the light beam reflected by the optical information recording medium.

It is preferable that the first polarization diffracting element divide the light beam into three light beams.

Note that the expression “divide the light beam into three light beams” indicates that the light beam emitted from the light source is divided into 0-order diffraction light (main beam) and ±1st order diffracting light (sub beams). This makes it possible to detect a tracking error signal in accordance with the three beam method.

Further, it is preferable that the second polarization diffracting element divide the returning light into non-diffraction light and diffraction light. More specifically, it is preferable that the second polarization light diffracting element include a second hologram region, which divides the returning light into (i) a light flux existing in a vicinity of a central portion of the returning light, and (ii) a light flux existing in a vicinity of a peripheral portion of the returning light.

It is preferable to arrange the optical integrated unit of the present invention such that: the first polarization light diffracting element includes a first hologram region having (i) a region through which light in a vicinity of a central portion of the light beam passes, and (ii) a region through which light in a vicinity of a peripheral portion of the light beam passes, and at least either grating widths or grating depths in the regions of the first polarization hologram region are different from each other.

According to the above structure, the first polarization light diffracting element includes the first hologram region having (i) the region through which the light in the vicinity of the central portion of the light beam passes, and (ii) the region through which the light in the vicinity of the peripheral portion of the light beam passes, and at least either the grating widths or the grating depths in the regions of the first polarization hologram region are different from each other. Therefore, when the light passes through such a first hologram region, the intensity distribution of the light is so corrected as to be flatter.

Therefore, the above structure makes it possible that: the light intensity distribution of the light beam emitted from the light source is caused to be flat, and then the light beam whose light intensity distribution becomes flat as such is collected on the optical information recording medium. Therefore, the above structure makes it possible to form a finer spot of the light beam on the optical information recording medium, with the result that a temporal resolution with respect to a reproduction signal, and an S/N ratio of the reproduction signal are improved. Further, the above structure makes it possible to provide an optical pickup for minimizing decrease of the light utilization efficiency by correcting the intensity of light emitted from a light source.

Particularly, in cases where the first polarization light diffracting element divides the light beam into the three light beams, the light intensity distribution of the 0-order diffraction light (main beam) of the three beams is made flat by the first hologram region.

Further, in cases where the first hologram region is a linear diffraction grating, it is preferable that the grating groove widths be closer to the half of the grating pitch in the region through which the light in the vicinity of the central portion of the light beam passes, and that the grating groove widths be smaller than the half of the length of the grating pitch in the region through which the light in the vicinity of the peripheral portion of the light beam passes. In this case, the decrease of the light intensity in the vicinity of the central portion of the 0-order diffraction light is greater than the decrease of the light intensity in the vicinity of the peripheral portion of the 0-order diffraction light (i.e., the decrease of the light intensity of the 0-order diffraction light is smaller as further from the vicinity of the optical axis of the 0-order diffraction light toward the peripheral portion thereof). This allows the light intensity distribution of the 0-order diffraction light to be closer to a flat light intensity distribution. This is further beneficial.

Further, it is preferable to arrange the optical integrated unit of the present invention such that: the first polarization light diffracting element and the second polarization light diffracting element are provided face to face in parallel with each other so as to cross with the optical axis of the light beam.

According to the above structure, the first polarization light diffracting element and the second polarization light diffracting element are provided face to face in parallel with each other so as to cross with the optical axis of the light beam. Therefore, by adjusting the position of the second polarization light diffracting element such that the light diffracted by the second polarization light diffracting element incidents on the second polarization light diffracting element, the position of the first polarization light diffracting element is adjusted at the same time. Therefore, the position adjustments of the first and second polarization light diffracting elements become easy in processes of assembling the optical integrated unit, and adjustment precision can be improved.

Particularly, the optical intensity distribution of the light beam is not precisely corrected when the first polarization light diffracting element, which has the light intensity distribution correction function of making the light intensity distribution flatter, is positioned such that the optical axis of the light beam is displaced from the center of the hologram first region, in which at least either the grating widths or the grating depths are different between (i) the region through which the light in the vicinity of the central portion of the light beam passes, and (ii) the region through which the light in the vicinity of the peripheral portion of the light beam passes. For this reason, application of the above structure is particularly effective.

Further, it is preferable that the optical integrated unit of the present invention further include: light guiding means, which has a function surface for allowing the light beam to pass therethrough and for reflecting the returning light, and which guides the returning light to the light receiving element.

According to the above structure, the light beam emitted from the light source enters the diffracting means after passing through the function surface of the light guiding means. With this, the length of the light path from the light source to the diffracting means becomes long.

Further, the light receiving element receives the returning light having been diffracted by the diffracting means and having passed through the light guiding means. That is, the returning light passes through the diffracting means, and then passes through the light guiding means, and then is received by the light receiving means. Therefore, the length of the light path of the returning light from the diffracting means to the light receiving element becomes long.

With this, even when the diffraction angle of the diffracting means is set small, the diffracted light (returning light) is finely separated in the light receiving element.

Particularly, in cases where the returning light is divided into the non-diffraction light and the diffraction light by the second polarization light diffracting element, it is possibly difficult for the light receiving element to receive the non-diffraction light and the diffraction light sufficiently separated from each other. However, according to the above structure, as the diffraction light and the non-diffraction light travel such a long light path, the space becomes longer therebetween, with the result that the diffraction light and the non-diffraction light are finely separated from each other in the light receiving element.

Further, it is preferable to arrange the optical integrated unit of the present invention such that: the function surface allows the first polarization component light of the light beam to pass therethrough, and reflects the second component light of the returning light.

With this, the returning light including the second polarization component and coming from the optical information recording medium is wholly reflected by the function surface, and is therefore guided efficiently to the light receiving element. Thus, the above structure makes it possible to further improve the utilization efficiency of the returning light.

Further, it is preferable to arrange the optical integrated unit of the present invention such that: the light guiding means includes a reflective surface for reflecting the returning light reflected by the function surface.

With this, the returning light diffracted by the second polarization light diffracting element can be reflected in a desired direction, and the light path can be further longer.

Note that: it is further preferable that the function surface and the reflective surface be parallel to each other. With this, the length of the light path in the light guiding means is the same even when the light incidents on any portion of the function surface (e.g., the peripheral portion of the function surface). Accordingly, the returning light reflected by the function surface can be efficiently guided to the light receiving element. Moreover, with this structure, the position of the light guiding means can be easily adjusted in the optical integrated unit.

It is preferable that the function surface be a polarization light beam splitter surface.

Further, it is preferable that the optical integrated unit of the present invention further include a ½ wavelength plate, which is provided between the function surface and the light source so as to cross with the optical axis of the light beam.

This allows increase of freedom in layout of parts such as the light source.

For example, the layout for the light source is restricted for the sake of allowing the first polarization component light of the light beam to pass through the function surface and of allowing the function surface to reflect the second polarization component light of the returning light, because the light source needs to be provided such that the light source emits the light beam including the first polarization component light. However, when the ½ wavelength plate is provided between the function surface and the light source so as to cross with the optical axis of the light beam, a light source for emitting a light beam including the second polarization component light different from the first polarization component light can be used without decreasing the light utilization efficiency. That is, the freedom in the layout for the light source is increased.

Further, it is preferable to arrange the optical integrated unit of the present invention such that: the light receiving element includes (i) a light receiving section for receiving the diffraction light and (ii) a light receiving section for receiving the non-diffraction light.

According to the above structure, the light receiving element includes the light receiving section for receiving the non-diffraction light, so that the non-diffraction light thus received can be used for detection of high-speed signals.

Specifically, the non-diffraction light can be used for the detection of the high-speed signals such as an RF signal, and a TES signal to be detected in accordance with the DPD method. On the other hand, the diffraction light can be used for detection of a servo signal.

Consider the following example. That is, in cases where the detection of the high-speed signals is carried out with the use of the diffraction light, the detection is influenced by wavelength fluctuation and common difference, so that the light receiving element needs to be so designed as to have a large size in consideration of fluctuation of the position of the light collected on the light receiving element. Such restriction in the area of the light receiving sections restricts high-speed reproduction of the RF signal. In contrast, the optical integrated unit according to the present invention uses the non-diffraction light for the detection of the high-speed signals, so that the area of the light receiving sections is not restricted as compared with the case where the high-speed reproduction signal is detected with the use of the diffraction light. This allows realization of good high-speed reproduction of the RF signal.

Further, it is preferable to arrange the optical integrated unit of the present invention such that: the light source is a semiconductor laser contained in a hermetically sealed package.

With this, the light source is not exposed to outside air, with the result that a property of the light source is less likely to be deteriorated.

Further, it is preferable to arrange the optical integrated unit of the present invention such that: a position of the light source is able to be adjusted with respect to respective positions of the light receiving element and the light guiding means.

With this, the respective positions of the light source and the light receiving element are precisely registered with each other, so that the returning light can be surely received by the light receiving element even in cases where the semiconductor laser contained in the package is used as the light source. This makes it possible to minimize the area of the light receiving section of receiving the non-diffraction light, with the result that the detection of the high-speed signals can be finely carried out.

Further, it is preferable to arrange the optical integrated unit of the present invention such that: a position of the first polarization light diffracting element is adjusted such that the light diffracted by the second polarization light diffracting grating incidents on the light receiving element.

According to the above structure, by adjusting the position of the second polarization light diffracting element such that the light diffracted by the second polarization light diffracting element incidents on the light receiving element, the position of the first polarization light diffracting element is adjusted at the same time. This makes it easy to adjust the respective positions of the first and second polarization light diffracting elements in the processes of assembling the optical integrated unit, and makes it possible to improve the adjustment precision.

Further, it is preferable to arrange the optical integrated unit of the present invention such that: the first polarization light diffracting element includes a first hologram region, which is smaller than an incident region in the first polarization light diffracting element, and which is larger than an collection region in the optical information recording medium, the incident region in the first polarization light diffracting element being a region on which the light beam emitted from the light source incidents, the collection region in the optical information recording medium being a region to which the light beam is collected.

By adjusting the position of the diffracting means such that the first hologram region is positioned in the center of the incident region, a coarse adjustment of the position of the diffracting means is done. Thus, the coarse adjustment of the position of the diffracting means becomes easy in the processes of assembling the optical integrated unit.

Further, it is preferable to arrange the optical integrated unit of the present invention such that: the diffracting means further includes a transparent element, and the transparent element has surfaces which are opposite to each other, and on which the first polarization light diffracting element and the second polarization light diffracting element are respectively provided.

According to the above structure, the first and second polarization light diffracting elements are respectively provided on the surfaces, opposite to each other, of the transparent element. Therefore, the first and second polarization light diffracting elements can be so manufactured as to be in one piece. This allows reduction of the number of parts.

As described above, the present invention provides either (i) an optical integrated unit in which light utilization efficiency is very high, and which has a stable recording/reproducing performance, or (ii) an optical pickup including the optical integrated unit. Therefore the present invention is applicable mainly in the optical information recording industry or the like.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. An optical integrated unit, comprising:
a light source for emitting a light beam including first polarization component light, to an optical information recording medium;
a light receiving element for receiving returning light, which is the light beam reflected by the optical information recording medium;
diffracting means for diffracting the first polarization component light in a direction toward the optical information recording medium such that decrease of light intensity of the light beam is smaller as further from a vicinity of an optical axis of the light beam toward a peripheral portion of the light beam; and
polarization component converting means, which is provided in a light path between the light source and the diffracting means, and which converts the returning light into second polarization component light different from the first polarization component light,
the diffracting means diffracting the second polarization component light in a direction toward the light receiving element.

2. The optical integrated unit as set forth in claim 1, wherein:
the first polarization component light and the second polarization component light are linear polarization light, and are polarized in directions orthogonal to each other.

3. The optical integrated unit as set forth in claim 1, wherein:
the polarization component converting means is a ¼ wavelength plate.

4. The optical integrated unit as set forth in claim 1, wherein:
the diffracting means includes:
a first polarization light diffracting element, which diffracts the first polarization component light but which allows the second polarization component light to pass therethrough; and
a second polarization light diffracting element, which diffracts the second polarization component light but which allows the first polarization component light to pass there through.

5. The optical integrated unit as set forth in claim 4, wherein:
the first polarization diffracting element divides the light beam into three light beams.

6. The optical integrated unit as set forth in claim 4, wherein:
the second polarization diffracting element divides the returning light into non-diffraction light and diffraction light.

7. The optical integrated unit as set forth in claim 4, wherein:
the first polarization light diffracting element includes a first hologram region having (i) a region through which light in a vicinity of a central portion of the light beam passes, and (ii) a region through which light in a vicinity of a peripheral portion of the light beam passes, and at least either grating widths or grating depths in the regions of the first polarization hologram region are different from each other.

8. The optical integrated unit as set forth in claim 4, wherein:
the second polarization light diffracting element includes a second hologram region, which divides the returning light into (i) a light flux existing in a vicinity of a central portion of the returning light, and (ii) a light flux existing in a vicinity of a peripheral portion of the returning light.

9. The optical integrated unit as set forth in claim 4, wherein:
the first polarization light diffracting element and the second polarization light diffracting element are provided face to face in parallel with each other so as to cross with the optical axis of the light beam.

10. The optical integrated unit as set forth in claim 1, further comprising:
light guiding means, which has a function surface for allowing the light beam to pass therethrough and for reflecting the returning light, and which guides the returning light to the light receiving element.

11. The optical integrated unit as set forth in claim 10, wherein:
the function surface allows the first polarization component light of the light beam to pass therethrough, and reflects the second component light of the returning light.

12. The optical integrated unit as set forth in claim 10, wherein:
the light guiding means includes a reflective surface for reflecting the returning light reflected by the function surface.

13. The optical integrated unit as set forth in claim 10, wherein:
the function surface is a polarization light beam splitter surface.

14. The optical integrated unit as set forth in claim 10, further comprising:
a ½ wavelength plate, which is provided between the function surface and the light source so as to cross with the optical axis of the light beam.

15. The optical integrated unit as set forth in claim 6, wherein:
the light receiving element includes (i) a light receiving section for receiving the diffraction light and (ii) a light receiving section for receiving the non-diffraction light.

16. The optical integrated unit as set forth in claim 15, wherein:
the non-diffraction light is used for detection of high-speed signals.

17. The optical integrated unit as set forth in claim 16, wherein:
the high-speed signals are an RF signal, and a TES signal to be detected in accordance with a DPD method.

18. The optical integrated unit as set forth in claim 15, wherein:
the diffraction light is used for detection of a servo signal.

19. The optical integrated unit as set forth in claim 1, wherein:
the light source is a semiconductor laser contained in a hermetically sealed package.

20. The optical integrated unit as set forth in claim 19, wherein:
a position of the light source is able to be adjusted with respect to respective positions of the light receiving element and the light guiding means.

21. The optical integrated unit as set forth in claim 4, wherein:
a position of the first polarization light diffracting element is adjusted such that the light diffracted by the second polarization light diffracting grating incidents on the light receiving element.

22. The optical integrated unit as set forth in claim 4, wherein:
the first polarization light diffracting element includes a first hologram region, which is smaller than an incident region in the first polarization light diffracting element, and which is larger than an collection region in the optical information recording medium, the incident region in the first polarization light diffracting element being a region on which the light beam emitted from the light source incidents, the collection region in the optical information recording medium being a region to which the light beam is collected.

23. The optical integrated unit as set forth in claim 4, wherein:
the diffracting means further includes a transparent element, and the transparent element has surfaces which are opposite to each other, and on which the first polarization light diffracting element and the second polarization light diffracting element are respectively provided.

24. An optical pickup, comprising an optical integrated unit,
said optical integrated unit, including:
a light source for emitting a light beam including first polarization component light, to an optical information recording medium;
a light receiving element for receiving returning light, which is the light beam reflected by the optical information recording medium;
diffracting means for diffracting the first polarization component light such that decrease of light intensity of the light beam is smaller as further from a vicinity of an optical axis of the light beam toward a peripheral portion of the light beam, so that the first polarization component is diffracted in a direction toward the optical information recording medium; and
polarization component converting means, which is provided in a light path between the light source and the diffracting means, and which converts the returning light into second polarization component light different from the first polarization component light,
the diffracting means diffracting the second polarization component light in a direction toward the light receiving element.
